(19) United States
(12) Patent Application Publication
(10) Pub. No.: US 2026/0003028 A1
(43) Pub. Date: Jan. 1, 2026

(54) RADIO CHIPSET WITH INTEGRATED RADAR FUNCTIONALITY

(71) Applicant: Amazon Technologies, Inc., Seattle, WA (US)

(72) Inventors: Durga Laxmi Narayana Swamy Inti, San Jose, CA (US); Ravi Ichapurapu, Morgan Hill, CA (US); Morris Yuanhsiang Hsu, Mountain View, CA (US); Maqsood Ahamed Abdul Careem, Sunnyvale, CA (US)

(21) Appl. No.: 18/759,487

(22) Filed: Jun. 28, 2024

(51) Int. Cl. G01S 7/00; G01S 7/282; G01S 7/288; G01S 7/292

(52) U.S. Cl. CPC G01S 7/006; G01S 7/282; G01S 7/2883; G01S 7/2922

(57) ABSTRACT

Technologies directed to providing a wireless chipset with integrated radar are described. A wireless device receives a first radar frame having leakage between a transmit antenna and a receive antenna. The wireless device receives a second radar frame having leakage between the transmit and receive antennas. The second radar frame is aligned to the first radar frame based on their respective leakages. A presence of a target is detected using the aligned second radar frame.

### BACKGROUND

A large and growing population of users is enjoying entertainment through the consumption of digital media items, such as music, movies, images, electronic books, and so on. The users employ various electronic devices to consume such media items. Among these electronic devices (referred to herein as endpoint devices, user devices, clients, client devices, or user equipment) are electronic book readers, cellular telephones, personal digital assistants (PDAs), portable media players, tablet computers, netbooks, laptops, and the like. These electronic devices wirelessly communicate with a communications infrastructure to enable the consumption of digital media items. These electronic devices include one or more antennas to wirelessly communicate with other devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless device having radar logic that is part of a microcontroller unit (MCU), radio logic that is part of an application processor (AP), and a connectivity chipset, according to one embodiment.

FIG. 2 is a flowchart illustrating a method of determining a presence or movement of a target using radar data, according to one embodiment.

FIG. 3 is a graph depicting a range fast Fourier transform (FFT) of a radar frame compared to a cross-frame cancellation output, according to one embodiment.

FIG. 4 illustrates an overall pipeline of the presence detection logic, according to one embodiment.

FIG. 5 illustrates a pre-processing pipeline of the presence detection logic, according to one embodiment.

FIG. 6 illustrates an aspect of the subject matter in accordance with one embodiment.

FIG. 7 illustrates a more detailed pipeline of the presence detection logic after pre-processing, according to one embodiment.

FIG. 8 is a flowchart depicting a finite state machine switching between dynamic and static modes, according to one embodiment.

FIG. 9 illustrates a decision-making process of a finite state machine, according to one embodiment.

FIG. 10 is a flowchart illustrating a method of switching between a radio mode and a radar mode, according to one embodiment.

FIG. 11 is a flowchart illustrating a co-existence protocol with radio and radar modes, according to one embodiment.

FIG. 12 is a block diagram of a wireless device with a baseband processor with integrated radio and radar functionality, according to one embodiment.

FIG. 13 is a block diagram of a wireless device with a chirp generator and digital dechirping logic, according to one embodiment.

FIG. 14 is a flowchart illustrating a method 1400 of detecting a presence of a target, according to one embodiment.

FIG. 15 is a block diagram of a wireless device with radio logic and radar logic, according to one embodiment.

### DETAILED DESCRIPTION

Technologies directed to providing a wireless chipset with integrated radar are described. Some sensing capabilities that may be used to provide natural and ambient interactions with a device are cameras, passive infrared (PIR), Wi-Fi® Channel State Information (CSI) based sensing, and radar. However, cameras have privacy concerns and static presence detection using PIR is difficult. Additionally, while CSI-based sensing does not require additional hardware and can work on any Wi-Fi-enabled device, there can be significant drawbacks. CSI-sensing solutions can detect false positives caused by inanimate objects. CSI-sensing solutions do not provide location information and cannot be used for room-level detection with a single device as it is impossible to identify a side of a link (i.e., Access Point (AP) side or device side) where motion happened. As such, a radar solution is left as the option. However, cost of the standalone radar solutions (e.g., a mmWave radar unit) may be cost-prohibitive, which may pose limits to scaling radar to products produced at a high volume.

Aspects and embodiments of the present disclosure overcome these deficiencies and others by reusing radio hardware (e.g., Wi-Fi®/Bluetooth® transmit (Tx) and receive (Rx) chains) to mimic traditional radar operation for presence detection. Aspects and embodiments of the present disclosure provide an integrated radar (e.g., frequency modulated continuous wave (FMCW) radar) in a wireless chipset, such as one that implements the Wi-Fi® and/or Bluetooth® technologies (hereinafter wireless chipset). The integrated radar in the wireless chipset re-uses the Wi-Fi®/Bluetooth® transmit chain for radar transmissions for sending chirps and a dedicated RX chain for receiving reflected signals from the chirps for the presence and localization of a user. Radar capability on the wireless connectivity solution provides credible presence or location information with minimal additional costs and creates opportunities for sensor fusion with other modalities. Aspects and embodiments of the present disclosure can enable low-cost ambient experience on wireless devices using radar integrated on Wi-Fi® chipsets without having the need for any other sensors.

Aspects and embodiments of the present disclosure provide presence detection logic that detects dynamic and static presence of a target within a field of view (FOV) of radar operations of the wireless device using radio hardware. Aspects and embodiments provide a process of aligning radar frames from separate radar operation cycles using leakage between transmit (TX) and receive (RX) antennas, due to the omnidirectional nature of antennas typically used in radio applications. Aspects and embodiments of the present disclosure provide a co-existence protocol that allows the radio hardware to be used in a radio capacity (e.g., radio mode) and a radar capacity (e.g., radar mode).

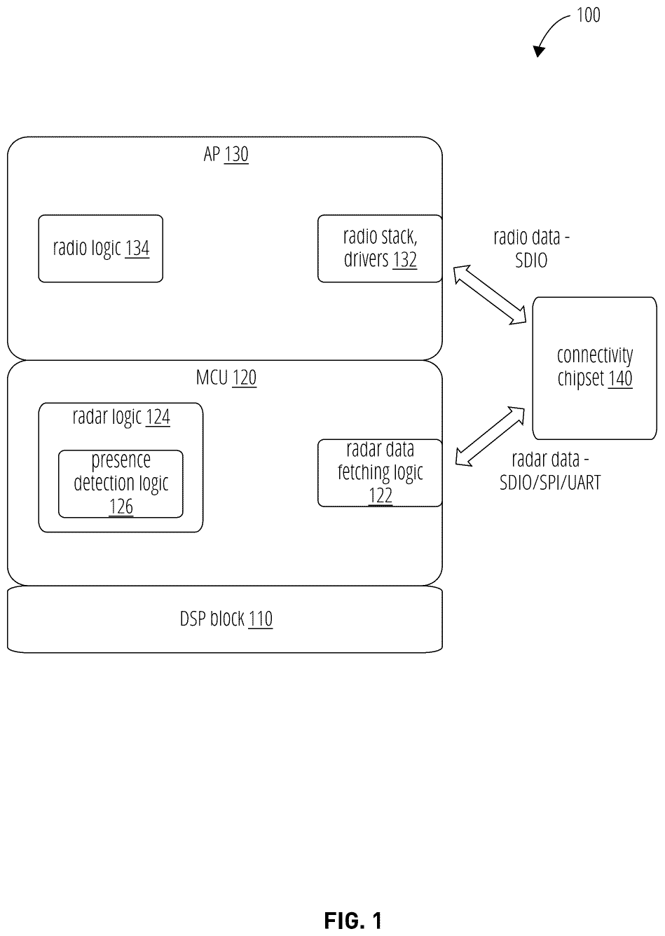

FIG. 1 illustrates a wireless device 100 having radar logic 124 that is part of a microcontroller unit (MCU) 120, radio logic 134 that is part of an application processor (AP) 130, and a connectivity chipset 140, according to one embodiment. In some embodiments, the wireless device 100 may include some combination of features of the wireless device 1200, the wireless device 1300, and the wireless device 1400.

In at least one embodiment, the wireless device 100 may also include one or more digital signal processing (DSP) blocks 110. The AP 130 may also include a radio stack and/or drivers 132. These drivers may interface directly with the hardware of the AP, such as a wireless network adapter. These drivers may handle low-level operations such as initiating hardware, managing radio frequencies, power levels, and handling data transmissions and receptions. Stacks, such as Wi-Fi® stacks, Bluetooth® (BT) stacks, or transmission control protocol (TCP) and internet protocol (IP) stacks, may be responsible for organizing and implementing network protocols that govern data exchange over the network. Thus, these radio stacks help ensure that data is correctly packaged, send, and received across a network of which the wireless device 100 belongs. The radio stack(s) and drivers 132 may communicate with the connectivity chipset 140 over a secure digital input output (SDIO) connection. This connectivity chipset 140, which manages wireless communications (e.g., Wi-Fi® or BT communications), communicates with the AP 130 through the SDIO. The drivers initialize and configure the connectivity chipset 140 for these wireless communications, manage data transmission and reception, and handle various control commands and status queries through the SDIO protocol. The radio drivers, possible part of an operating system of the AP 130 or wireless device 100, interacts with these drivers by managing the routing and processing of data packets to and from higher-level applications and ensures that data sent to and from the connectivity chipset 140 is correctly formatted and timed.

The connectivity chipset 140 may include components designed to allow the connectivity chipset 140 to handle both transmit (TX) and receive (RX) signals. The connectivity chipset 140 may include a baseband processor operatively coupled to front-end radio frequency (RFFE) circuitry. that prepares digital data for transmission by converting it into a signal suitable for radio frequency (RF) transmission (e.g., among other things, modulation and encryption). This RFFE may also demodulate incoming RF signals back into digital format for the baseband processor to process and generate data interpretable by the MCU 120 or AP 130.

The MCU 120 may include radar data fetching logic 122. Radar data generated by the connectivity chipset 140 may be sent to the MCU 120 via the radar data fetching logic 122. This radar data may be passed from the connectivity chipset 140 to the MCU 120 using an SDIO connection, a serial peripheral interface (SPI) connection, a universal asynchronous receiver/transmitter (UART) connection, or the like. In embodiments where an SDIO connection is used to pass radar data from the connectivity chipset 140 to the MCU 120, The same SDIO connection may be used between the AP 130 and the connectivity chipset 140. Here, at times, the MCU 120 may need to access the SDIO interface of the connectivity chipset 140 without waking the AP 130 (e.g., while the AP 130 is in suspend mode). This may be because the MCU 120 is always active (e.g., always awake), while the AP 130 is only active while the wireless device 100 is in use (e.g., if the wireless device 100 is a television, while the television is on). A first option may be dynamic SDIO handover between the AP 130 and the MCU 120 depending on the need and traffic pattern of the data to and from the connectivity chipset 140. This would allow both the MCU 120 and AP 130 to have complete access to the SDIO. However, this first option may introduce unwanted software complexity, latency incurred due to the SDIO handover, and radio data drops (e.g., data packet drops). A second option would be having the MCU 120 always control the SDIO interface and sharing radio data with the AP 130 via shared memory. This is a more stable implementation when compared to option A (though option A is still viable) but would still have significant latency between receiving radio data and sending it to the AP 130.

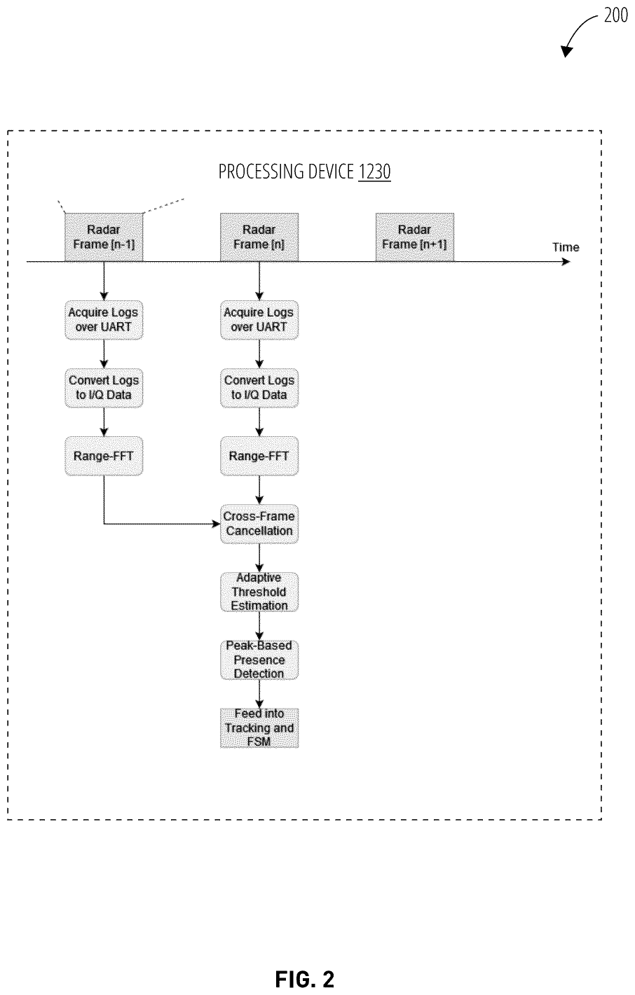

The MCU 120 may also include radar logic 124. The radar logic 124 may be part of the MCU 120 to allow radar operations to occur whether or not the AP 130 is in active (e.g., on) or suspend (e.g., off) mode. For example, it may be desired that the wireless device 100 performs radar operations while not in use (e.g., television is not being watched) to determine whether the wireless device 100 should be in use. In the example where the wireless device 100 is a television, radar operations may be used to detect an ingress of a person or user, which may be a trigger to put the television in use (e.g., turn it on). The radar logic 124 may include presence detection logic 126 that is used to determine a presence or motion of a target based on radar data received by the connectivity chipset 140. This target may be a person or another desired object. This radar logic 124 is explained in more detail below with respect to at least FIGS. 2-7.

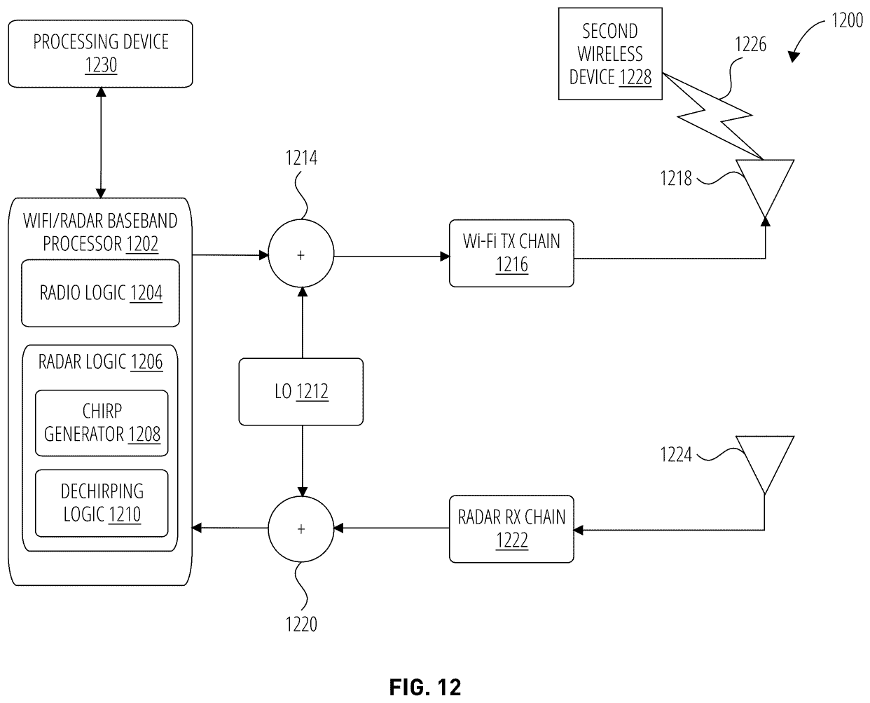

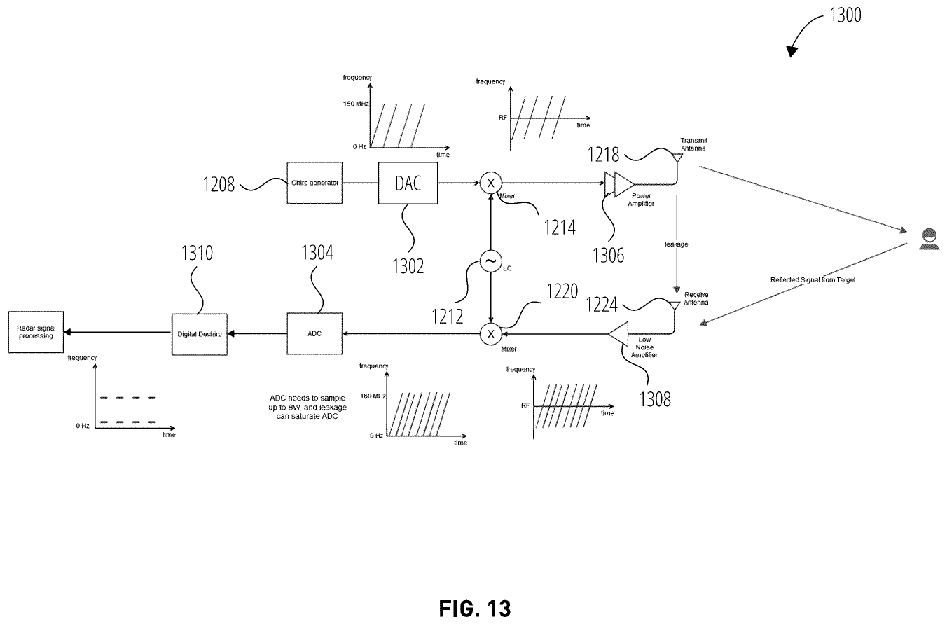

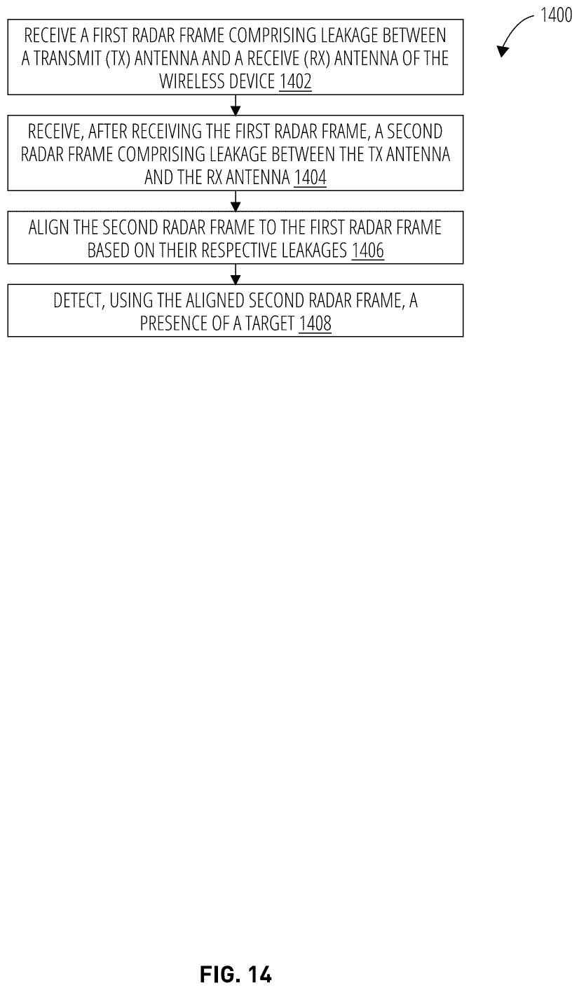

FIG. 2 is a flowchart illustrating a method 200 of determining a presence or movement of a target using radar data, according to one embodiment. Some or all of the operations of the method 200 may be performed by the presence detection logic 126. The method 200 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the method 200 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the method 200. The method 200 can be performed by other devices described herein.

The method 200 may iteratively generate radar frames, which are compared to each other to determine a presence or movement of a target. A radar frame refers to a complete set of data captured by a radar system during a single measurement cycle. This measurement cycle may refer to a time transmission interval (TTI) or a different predetermined metric that denotes a beginning time and an ending time. Each radar frame typically includes information about the objects detected by the radar, such as their distance, reflectivity strength, velocity, or sometimes angle (e.g., if there are at least two RX antennas). In short, each radar frame is a snapshot in time of positions of target(s) and other objects within a field of view (FOV) of a radar. By comparing a radar frame to another radar frame, movements and positions of objects and targets within the FOV may be analyzed and measured.

In some embodiments, the processing logic acquires a first set of values (e.g., logs) for a first radar frame (e.g., radar frame [n-1]). This first set of values may be a representation of the FOV of the radar at a first time. The processing logic may convert this first set of values into in-phase and quadrature (IQ) samples which are thereafter passed through a range fast Fourier transform (FFT). The range FFT transforms the first set of values into a second set of values in the frequency domain. These values of the second set may each represent a reflected signal strength at a different distance (e.g., distance bin) from the radar.

Subsequent to acquiring the first set of values for a first radar frame, the processing logic may acquire a third set of values for a second radar frame (e.g., radar frame [n]). This second radar frame may represent the FOV of the radar at a second time after the first time. The processing logic may generate a fourth set of values using the third set of values in a manner similar to how the second set of values is generated, as described above.

After generating the fourth values, the processing logic may perform a cross-frame cancellation by comparing the fourth set of values to the second set of values. The processing logic may perform the cross-frame cancellation by comparing values of the second set of values and the fourth set of values that correspond to a same distance bin. The cross-frame cancellation may generate a fifth set of values. Each value of the fifth set of values may be equal to difference between a value of the second set of values and a value of the fourth set of values that each correspond to the same distance bin. Any non-zero (or non-negligible) value of the the fifth set of values may be indicative of a presence or movement of a target or other object within the FOV of the radar.

While the above description describes a cross-frame cancellation between two radar frames, one of skill in the art would appreciate that multiple previous radar frames may be used in lieu of a single previous radar frame (e.g., the first radar frame). For example, the fourth set of values described above may be compared to another set of values corresponding to an average of any number of previous radar frames.

To determine whether any value of the fifth set of values is indicative of a presence or movement of a person or object, the processing logic may compare each value of the fifth set to a threshold. This threshold may be different for each value of the fifth set. In at least one embodiment, the threshold to which a value of the fifth set is compared may be dependent on one or more of (i) a distance to the radar to which the value corresponds or (ii) past values of historical fifth sets that also correspond to the same distance to the radar. In some embodiments, the threshold may be an adaptive or dynamic threshold that accounts for sets of values corresponding to any number of past radar frames. In other embodiments, the threshold may be fixed. If none of the values of the fifth set satisfies the corresponding threshold, further signal processing may be prevented.

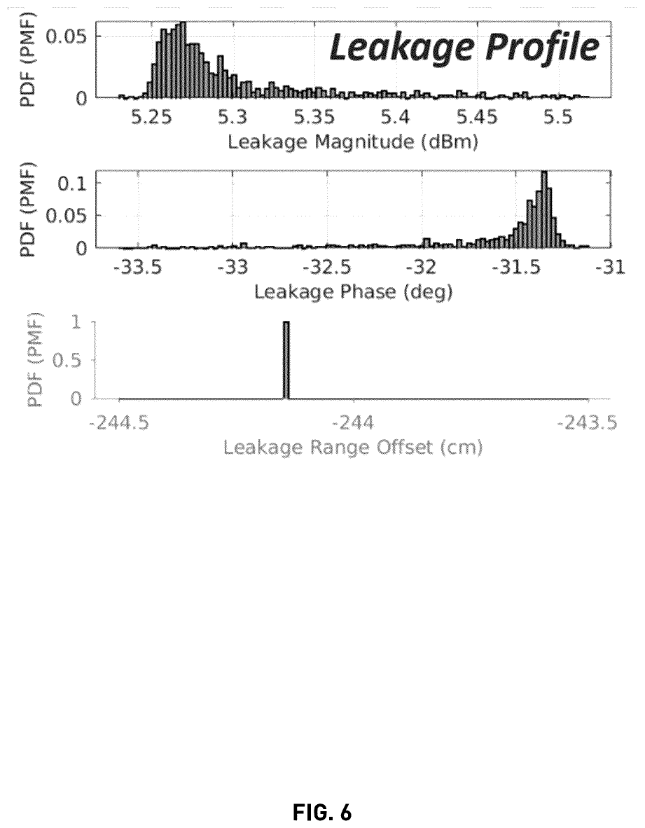

If at least one value of the fifth set of values satisfied the corresponding threshold, the processing logic may determine that there is a presence or motion of a target (e.g., a person) within the FOV of the radar. Once this presence or motion has been verified, the processing logic may perform a peak-based presence detection operation to determine one or more distances at which the target(s) are likely to be located from the radar. These distances may be used as inputs into a tracking system (e.g., target tracking of block 410) and/or a finite state machine, such as the finite state machine (FSM) 800 described below with respect to FIGS. 6A-B. In one embodiment, the processing logic may only identify the distance of a highest peak value (e.g., absolute maximum) within the fifth set of values. In another embodiment, the processing logic may only identify a closest peak value of the fifth set of values. In other embodiments, the processing logic may identify all peak values within the fifth set of values that are over a predetermined threshold.

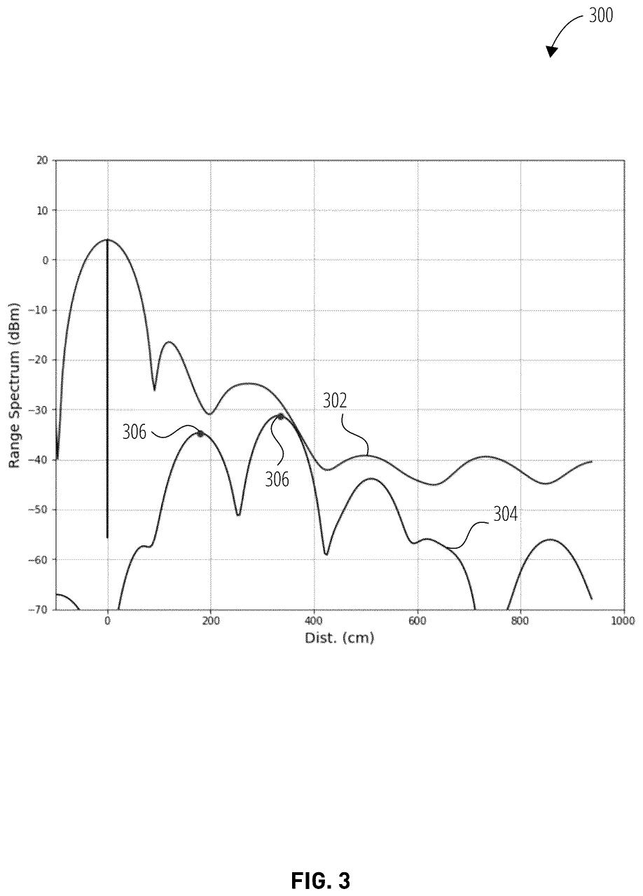

FIG. 3 is a graph depicting a range FFT 302 of a radar frame compared to a cross-frame cancellation output 304, according to one embodiment. The horizontal axis of the graph 300 may correspond to a distance (e.g., centimeters (cm)) from a radar (e.g., a distance bin), and the vertical axis may correspond to a signal strength represented in decibels relative to one milliwatt (dBm). With context to FIG. 2 above, this range FFT 302 may correspond to the second radar frame (e.g., radar frame [n]). The cross-frame cancellation output 304 may correspond to a comparison of the range FFT 302 and a past range FFT corresponding to a past radar frame, such as the first radar frame (e.g., radar frame [n-1]). However, the past range FFT may correspond to any past radar frame (e.g., radar frame [n-5]) or any number of past radar frames (e.g., an average of [n-1], [n-2], and [n-3], or a filter output derived from an infinite impulse response (IIR), finite impulse response (FIR), or the like).

As described above in FIG. 2, once a cross-frame cancellation has been performed, the result of the cross-frame cancellation may be indicative of movement or presence of a target within the FOV of the radar. A higher dBm may be indicative of movement or presence of a target at a specific distance from the radar. For example, two peak values 306 at approximately 190 cm and 350 cm may be located on the cross-frame cancellation output 304. These two peak values may have signal strengths of approximately −35 dBm and −31 dBm, respectively, these strengths may be higher than respective thresholds for those particular distances from the radar. Thus, one or more of the peak value 306 at 190 cm or the peak value 306 at 350 cm may be identified and fed into a tracking system and/or finite state machine of a wireless device.

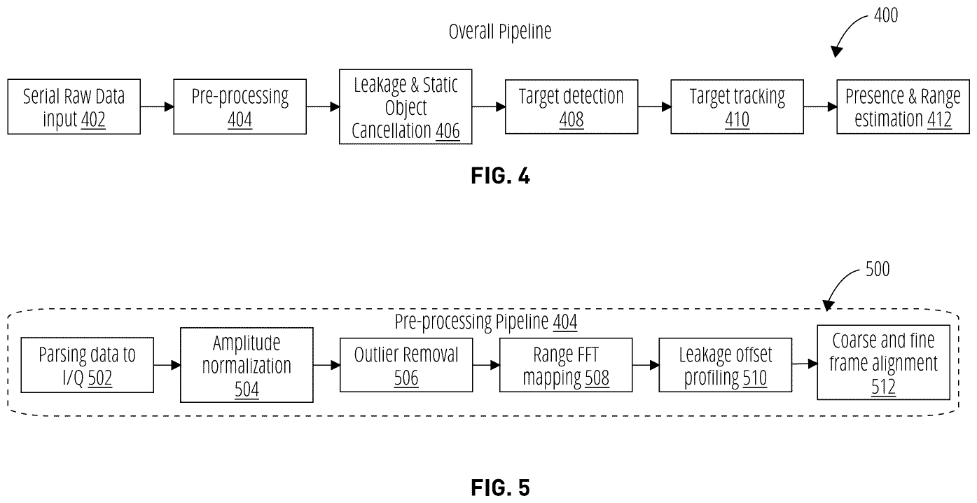

FIG. 4 illustrates an overall pipeline 400 of the presence detection logic, according to one embodiment. Some or all of the operations of the overall pipeline 400 may be performed by the presence detection logic 126. The overall pipeline 400 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the overall pipeline 400 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the overall pipeline 400. The overall pipeline 400 can be performed by other devices described herein.

First, the processing logic may receive serial (e.g., time-series) raw data as an input at block 402. This raw data may be received as a radar frame and be pre-processed at block 404. This pre-processing may include signal normalization, transforming the raw data into a range FFT, remove outliers, correcting for residual artifacts of digital dechirping, and synchronizing (e.g., aligning) the radar frame to past radar frames. This pre-processing is described below in more detail with respect to FIG. 5.

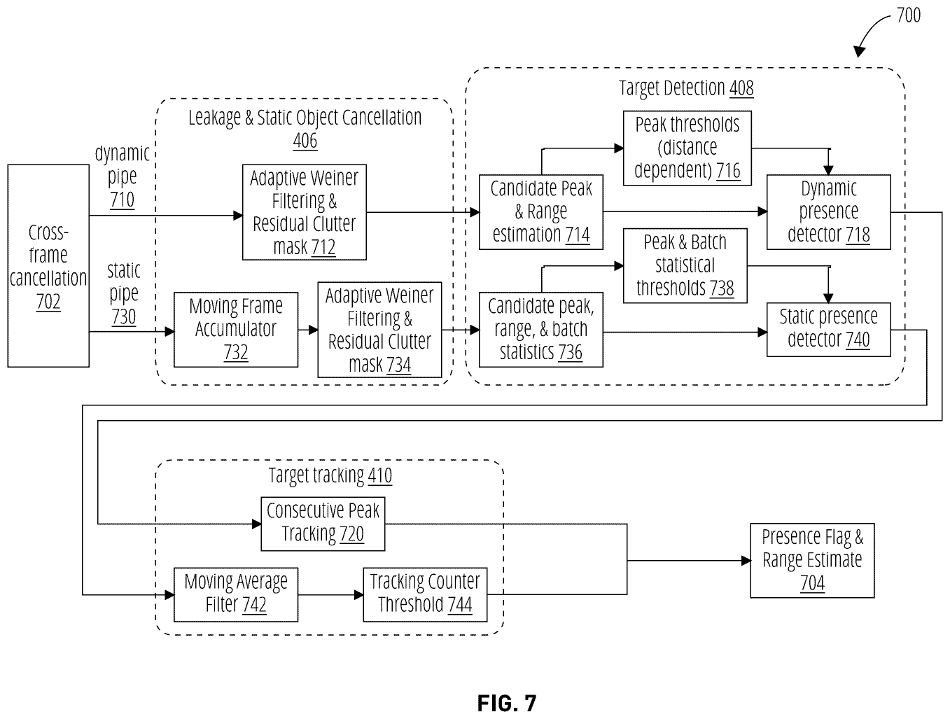

Once the radar frame has been pre-processed, leakage and radar returns originating from static objects within the FOV of the radar are canceled using cross-frame cancellation techniques at block 406. In at least one embodiment, an adaptive Weiner filtering technique may be used to further suppress noise within the set of data resulting from the cross-frame cancellation. After the leakage and static object cancellation, the processing logic may analyze the data of the radar frame to determine whether a target has been identified at block 408. This target detection may be performed by determining peak value(s) of the data and comparing them to distance-dependent thresholds. The outcome of this comparison may be used by dynamic or static presence detector logic to determine or confirm a presence or movement of the target. This target tracking is described in more detail in FIG. 7.

An output of the dynamic or static presence detection logic may be used to track the target over multiple radar frames at block 410. If dynamic presence detection logic was used, the processing logic may confirm the presence of a target if multiple consecutive peak values each satisfy a distance-dependent threshold. If static presence detection logic was used, the processing logic may confirm the absence of the target if a threshold number of radar frames did not have a peak value that satisfied a distance-dependent threshold. Confirmation of dynamic or static presence (or the absence thereof) is described in more detail in FIGS. 6-8.

A presence flag and range estimate of a target may be outputted to other applications of the wireless device at block 412. This may allow these other applications to cause the wireless device to perform one or more actions based on the presence flag or range estimate.

FIG. 5 illustrates the pre-processing pipeline 500 of block 404 of the presence detection logic, according to one embodiment. Some or all of the pre-processing pipeline 500 may be performed by the presence detection logic 126. The pre-processing pipeline 500 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the pre-processing pipeline 500 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the pre-processing pipeline 500. The pre-processing pipeline 500 can be performed by other devices described herein.

At block 502, the processing logic may parse input serial data to in-phase and quadrature (IQ) data. This parsing may be performed by decoding the serial data into digital signals, identifying radar frame boundaries, and then separating in-phase and quadrature components from the decoded data. In at least one embodiment, only the in-phase or quadrature data may be used as radar data to determine the presence or motion of a target.

At block 504, the processing logic may normalize the amplitude of the radar data. Amplitude normalization may scale the amplitude of the radar data of a signal to a specific range, typically (but not necessarily) between-1 and 1, to ensure uniform amplitude levels across radar frames. Amplitude normalization helps in mitigating the impact of varying environmental noise, which can affect the consistency and comparability of analyses of the observed reflected signals. Amplitude normalization may typically be performed by dividing the signal by its maximum absolute amplitude, thus preserving the original signal's waveform and characteristics.

At block 506, the processing logic may remove outlier data. Outlier data, if left within the radar data, can skew any results of subsequent processing of the radar data. This outlier data may be removed using any suitable process known to one having skill in the art. In at least one embodiment, an outlier value within the radar data may be replaced by an adjacent value within the radar data. In another embodiment, the outlier value may be canceled such that the replacement value is insignificant (e.g., well below a noise floor of the radar data, such as −80 dBm).

At block 508, the processing logic may map the radar data to a range FFT, e.g. may utilize a fast fourier transform operation to generate, based on the radar data, a range FFT. This range FFT may represent a strength of reflected signals at different distances from a radar unit. A range FFT may be represented by a graph, such as range FFT 302 of FIG. 3. The radar data, which up to this point has been time-domain data, is used to generate a radar data set in the frequency domain, namely the range FFT described above.

At block 510, the processing logic may profile a leakage offset in the range FFT. To profile the leakage, the processing logic may be analyzed using probabilities of the leakage having a certain magnitude value, phase value, or range offset value. In at least one embodiment, the leakage range offset value may be known, as the physical relationship between the TX and RX antenna is fixed (e.g., the TX and RX antennas are in fixed positions on the wireless device). These probabilities may be generated using historical radar data to generate a probability density function (PDF). A PDF is used to describe how the amplitude of noise is distributed over time. This PDF (or other method of generated probabilities of the leakage having particular magnitude value, phase value, or range offset value) may be used to profile the leakage within radar data. From radar frame to radar frame, a respective peak magnitude values for the leakage may change, introducing a magnitude offset. Additionally, from radar frame to radar frame, a phase corresponding to these peak magnitude values for the leakage may also change, introducing a phase offset. These changes may be induced by temporal variation Once the leakage is profiled, the processing logic may align the range FFT to one or more previous range FFTs using their respective leakages. In particular, the processing logic may align the range FFT (e.g., first radar data set) to a previous range FFT (e.g., second radar data set) in such a way to reduce or eliminate the magnitude and phase offsets between the two. An exemplary profile of a leakage offset is shown in FIG. 6 where three PDFs depict probabilities of radar data having respective leakage magnitude, leakage phase, and leakage range offset.

At block 512, the processing logic may align the range FFT (e.g., current range FFT) to a past range FFT that corresponds to a previous radar frame (e.g., radar frame [n-1] of FIG. 2). The processing logic may align the range FFT and previous range FFT based on their respective leakages. Aligning the current range FFT to the previous range FFT based on the profiled leakage magnitude may provide a coarse alignment, which may be sufficient for some radar applications. However, to align the current range FFT more finely to previous range FFT(s), the processing logic may additionally align these based on the leakage phase or leakage range offset. This finer alignment may compensate for temporal variations between the current range FFT and the previous range FFT. Once this the range FFT is aligned to the previous range FFT, the leakage may be filtered along with residual clutter using a filtering technique, such as a residual clutter mask or machine learning techniques (e.g., models trained to recognize patterns within the radar data indicative of leakage or residual clutter). In some embodiments, once the alignment is finished, the leakage (and residual clutter) may be cancelled via cross-frame cancellation within a one-tap Weiner filter, as is explained below in FIG. 7.

In at least one embodiment, this alignment of current and previous range FFTs described above may be supplemented or replaced by analog alignment circuitry that utilizes coupled paths to align the magnitude and phase of the current and previous radar frames, as they are received. This analog alignment circuitry may be a system that aligns both magnitude and phase of an incoming signal (e.g., the current radar frame) by splitting the signal into multiple paths, each of which can be adjusted individually before being recombined, which allows for a more detailed and fine-tuned alignment. The analog alignment circuitry may include various filters, amplifiers, and phase shifters along each path to manipulate the signal characteristics. In one embodiment, this analog alignment circuitry may reduce complexity or increase accuracy of post-FFT alignment. In another embodiment, this analog alignment circuitry may render the post-FFT alignment optional or unnecessary.

In accordance with one or more implementations, first radar data for a first frame is generated based on signal received at a receive antenna, with the first radar data representing both a reflection of a signal transmitted using a transmit antenna at a first time and and leakage from the transmit antenna at a second time which is after the first time. A fast fourier transform operation is used on the first radar data to determine first range FFT data, with the first range FFT data indicating magnitude values for various frequency bins corresponding to various distances. Second radar data for a second frame immediately subsequent to the first frame is generated based on signal received at the receive antenna, with the second radar data representing both a reflection of a signal transmitted using a transmit antenna at a third time that is after the first time and leakage from the transmit antenna at a fourth time which is after the second time and after the third time. A fast fourier transform operation is used on the second radar data to determine second range FFT data, with the second range FFT data indicating magnitude values for various frequency bins corresponding to various distances. In accordance with one or more implementations, an approach involves determining, for each range FFT data, one or more samples or bins corresponding to leakage. In accordance with one or more implementations, leakage is identified/detected based on having a highest magnitude, or having a magnitude above a threshold, or having a magnitude that matches a leakage profile, or having a magnitude/phase/range that matches a leakage profile. In accordance with one or more implementations, radar logic for estimating a distance (determining a distance bin) is based on an estimated round trip time, and a timing inconsistency between consecutive frames that manifests as an inconsistency in distance estimates between the frames may be remediated by aligning the first range FFT data to the second range FFT data. In accordance with one or more implementations, the first range FFT data is aligned to the second range FFT data based on aligning an identified leakage sample or bin (or samples) from the first range FFT data to an identified leakage sample or bin (or samples) from the second range FFT data.

While alignment between radar frames may not be needed in some radar applications, radar and radio modes sharing a TX chain may necessitate such alignment. This may be because switching between radar and radio modes may cause timing issues, such as a clock reset or clock phase shift. As the wireless device switches between these modes, a clock may be reset, which may cause a clock offset between the previous radar frame (e.g., [n-1]) and the current radar frame with the range FFT (e.g., [n]). By (i) profiling the leakage offset and (ii) aligning the range FFT to the previous FFT based on their respective leakage profiles, the processing logic is preparing for cross-frame cancellation, which should significantly reduce or eliminate the leakage (and reflected signals from static objects). This clock reset may also cause temporal variations in the magnitude or the phase of the radar data.

In accordance with one or more implementations, first radar data for a first frame is generated based on signal received at a receive antenna, with the first radar data representing both a reflection of a signal transmitted using a transmit antenna at a first time and leakage from the transmit antenna at a second time which is after the first time, and second radar data for a second frame immediately subsequent to the first frame is generated based on signal received at the receive antenna, with the second radar data representing both a reflection of a signal transmitted using a transmit antenna at a third time that is after the first time and leakage from the transmit antenna at a fourth time which is after the second time and after the third time. A signature or profile of the leakage signal in the first radar data is matched to a signature or profile of the signal transmitted at the first time to determine first timing information. A signature or profile of the leakage signal in the second radar data is matched to a signature or profile of the signal transmitted at the third time to determine second timing information. The first timing information and/or the second timing information is utilized to adjust (e.g. a time offset is used that is determined based on the first timing information and the second timing information) time information associated with samples of the first radar data or second radar data prior to generating fast fourier transform range data.

FIG. 7 illustrates a more detailed pipeline 700 of the presence detection logic 126 after pre-processing, according to one embodiment. The blocks depicting the pipeline 700 each represent one or more operations of the presence detection logic 126. These operations of the presence detection logic 126 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the pipeline 700 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the pipeline 700. The pipeline 700 can be performed by other devices described herein.

In at least one embodiment, the presence detection logic 126 may have at least two pipelines-a dynamic pipe 710 and a static pipe 730. As used herein, a pipe may refer to a set of processing elements arranged in sequence where the output of one element is the input to the next. In some cases, a pipeline (such as the pipeline 700) may have parallel pipes that may be used to serve different purposes. These parallel pipes may be executed in parallel or separately. For example, in at least one embodiment, a flag or other indicator may be used to indicate which of the parallel pipes is to be used. In some embodiments, these pipes may be executed in parallel, but output(s) from only one of the parallel pipes may be utilized in upstream applications. Here, the dynamic pipe 710 may be used to detect movement of a target within a monitored environment. This movement may be a person walking or otherwise moving within the FOV of the wireless device. As the dynamic pipe 710 is designed to detect relatively large movements (e.g., a person walking compared to a person laying down on a couch), the dynamic pipe 710 may utilize frame-level processing. Conversely, the static pipe 730 may be used to determine whether the presence of the target (e.g., person) is detected within the monitored environment. This presence may be determined by looking for smaller movements than those for which the dynamic pipe 710 is designed to detect (e.g., hand movements, head movements, breathing, or the like). These smaller movements may be easier to detect by utilize batch-level processing, where radar data from multiple radar frames (e.g., multiple radar mode cycles) create a “batch” that is analyzed within the static pipe 730. This “batch” may include the current radar frame and at least one historical radar frame generated an amount of time (e.g., 1 second, 5 seconds, 10 seconds, 30 seconds) before the current radar frame.

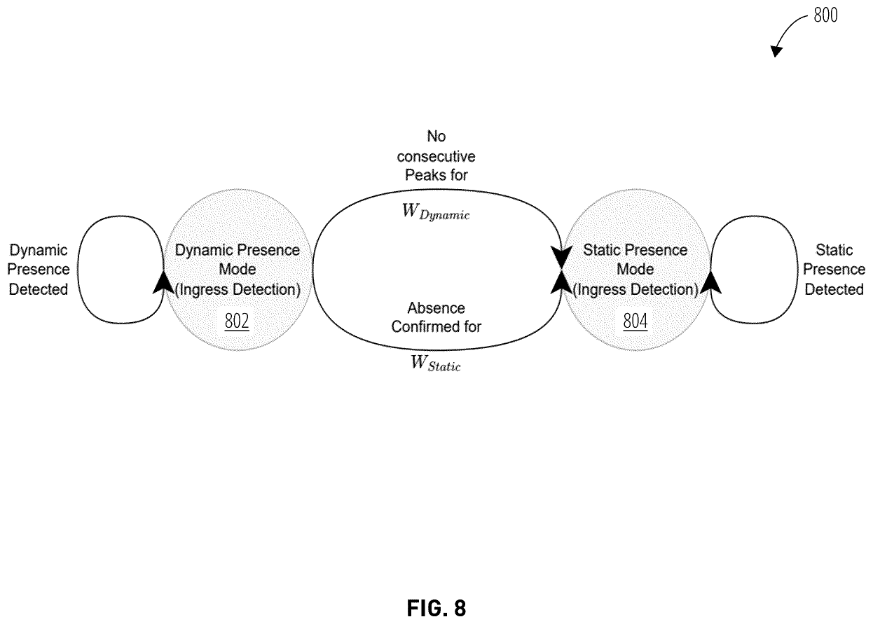

In some embodiments, the dynamic and static pipes 710, 730 are operational for each radar frame. In other embodiments, only one of the dynamic and static pipes 710, 730 is operational based on a controller, such as a finite state machine (FSM). This is explained in more detail below with respect to FIG. 8.

First, consider the dynamic pipe 710. Pre-processed data from block 702 is sent to block 712, where the pre-processed data is filtered by an adaptive Weiner filter. This pre-processed data may be a first radar data set that represents a range FFT of the current radar frame. The adaptive Weiner filter may perform a cross-frame cancellation using the radar data set and a second radar data set corresponding to a previous or historical radar frame (e.g., radar frame [n-1] from FIG. 2). This adaptive Weiner filter may be represented by the following equation (1):

$$Equation ( 1 )$$

$${f}_{filtered} [ n ] = f [ n ] - {C}_{n} f [ n - 1 ] , where {C}_{n} = \vert {P}_{n - 1} \vert \vert {P}_{n} \vert {e}^{j ( ∠ {P}_{n} ∠ {P}_{n - 1} )}$$

Here, ƒ[n] is the first radar data set (i.e., current range FFT), ƒ[n-1] is the second radar data set (i.e., previous range FFT), Cₙ is the tap coefficient, Pₙ is the peak value (i.e., maximum magnitude) of the current range FFT, and Pₙ₋₁ is the peak value of the previous range FFT. In at least one embodiment, the tap coefficient Cₙ is calculated based on the ratio of the peak values of the current and previous radar frames, and the phase different between these peak values. This tap coefficient Cₙ may help reduce the impact of leakage and static objects in the current radar frame based on these characteristics observed in the previous radar frame. Additionally, because the tap coefficient Cₙ is also based on the phase difference of these peak values, the tap coefficient Cₙ may also help reduce the effects of temporal variations between the previous and current radar frames. In at least one embodiment, a resulting filtered data (e.g., third radar data set) may be outputted by the adaptive Weiner filter that represents differences within the FOV of the wireless device between the first and second radar frames.

In some embodiments, due to the nature of digital dechirping, static objects such as furniture, walls, or the like can manifest as time varying clutter artifacts. The digital nature of the digital dechirping process generally means that the reflected signals from static objects are sampled and integrated over time, which means that variations in each sampling instance (due to electronic noise, temperature variations, clock phase variation, or other factors) can cause static objects to appear to have fluctuations in their detected positions or characteristics, creating what is perceived as time-varying clutter. Additionally, some techniques used to digitally dechirp reflected signals, such as windowing, filtering, or quantization, can inadvertently modify the reflected signal characteristics corresponding to these static objects and cause these static objects to manifest as time-varying features of the radar signal (e.g., look like a moving target). This phenomena of digital dechirping may also be effectively filtered by having a tap coefficient that takes into account the phase difference between the peak values of the current and previous radar frames.

At block 712, a residual clutter mask may also be used to filter the third radar data set. A residual clutter mask is a radar signal processing tool designed to identify and suppress clutter that remains after initial filtering processes. This mask is typically created based on historical data or real-time analysis to pinpoint range bins where clutter (e.g., static objects, or unfiltered leakage) is known to frequently appear. In general, purpose of the mask is to minimize the influence of unwanted echoes that could obscure or be mistaken for actual targets. When applying a residual clutter mask to a range FFT, such as the third radar data set, the magnitude value for each range bin is compared against the clutter mask thresholds established for those specific areas. If the magnitude in a particular range bin falls below the threshold set by the mask, it is considered clutter and may be suppressed or ignored. Suppressing or ignoring these magnitudes can help reduce the likelihood of false positives and improve the clarity and confidence level of a target detection. In at least some embodiments, the processing logic may also use a band pass filter on at least low range bins (e.g., range bins closest to the wireless device) and high range bins (e.g., range bins furthest from the wireless device). This band pass filter may be designed to reduce or eliminate noise from device vibration (low range bins) and multipath (high range bins). In at least some embodiments, this band pass filter may also reduce reflected signals that reflect from objects behind a wall (high range bins).

The third radar data set is sent to block 714 where one or more candidate peak values of the third radar data set may be identified. These candidate peak values may also be referred to as peak values, as these candidate peak values represent magnitude values. The processing logic may identify any number of local maximums (including the absolute maximum) of the third radar data set as candidate peak values. In some embodiments, the processing logic may identify magnitudes over a candidate peak threshold as a candidate peak value. Once these candidate peak value(s) have been identified, the processing logic may determine which range bins correspond to the candidate peak value(s). The processing logic may have determined these range bins while identifying the candidate peak value(s).

These range bins may be sent to block 716 where the processing logic identifies a peak threshold for each range bin. Each of these range bin(s) may have a different peak threshold. As such, these peak thresholds may be distance dependent. These peak thresholds may be determined based on historical data to find a magnitude for each range bin that (i) is far enough above typically noise levels of the third radar data set to avoid frequent false positives (e.g., noise causing the magnitude to satisfy the peak threshold) and (ii) low enough to capture movement of a target. The peak thresholds for the dynamic pipe 710 may be determined using historical radar data. In some embodiments, these peak thresholds for the dynamic pipe 710 may be based on a constant false alarm rate (CFAR), cell averaging (CA), or ordered statistics (OS) approach to thresholding for static detection. In at least one embodiment, these peak thresholds for the dynamic pipe 710 may be dynamic and take into account previous radar frame(s).

At block 718, the processing logic may compare the candidate peak values to their respective peak thresholds. If at least one of the candidate peak values satisfies their respective peak threshold, the processing logic may indicate that dynamic presence of a target has been detected. If none of the candidate peak values satisfy their respective peak threshold, the processing logic may indicate that dynamic presence of a target has not been detected (or, in an alternative embodiment, simply fail to indicate that dynamic presence of a target has been detected).

At block 720, the processing logic may track how many consecutive radar data sets each representing cross-cancellation between radar frames (e.g., the third radar data set, and historical third radar data sets) have at least one candidate peak value that satisfies its respective peak threshold. Once a first threshold number of consecutive radar data sets have a candidate peak value that satisfies its respective peak threshold, the processing logic may determine that a dynamic motion of a target has been detected, cause a presence flag to be enabled, and determine a range estimate of at least one candidate peak value of the third radar data set. In some embodiments, the range estimate may be based on the range bin of the candidate peak value closest to the wireless device that satisfies its respective peak threshold. For example, if a first peak value candidate around one meter from the wireless device and a second candidate peak value around two meters from the wireless device each satisfy their respective peak thresholds, the processing logic may determine one meter as the range estimate. In other embodiments, the range estimate may be based on the range bin of the candidate peak value with the highest magnitude value of the third radar data set that satisfies its respective peak threshold.

At block 704, the processing logic may send this presence flag and/or the range estimate to one or more other applications on the wireless device, such as a unified sensor framework whose data is used to cause one or more actions on the wireless device. For example, if the wireless device is a television, the presence flag and/or range estimate may be used to turn the television screen on (e.g., when a target ingresses) or off (e.g., when the target is no longer detected, or when a target egresses). As another example, if the wireless device controls a light source, the presence flag and/or range estimate may be used to turn on the light source at optionally different levels of brightness, depending on how far away the target is from the wireless device. In another example, if the wireless device is an internet of things (IoT) device, the presence flag may enable any of various functions that may be desired upon detecting the presence of a person or other type of user. The presence flag and range estimate may also be used in other applications of the wireless device, such as enabling or disabling visual features, audio features (e.g., directable audio, sound beaming), or others.

Here, consider the static pipe 730. At block 732, the processing logic may combine the pre-processed data (also referred to as first radar data set) with that of previous radar frames. This combination may be performed by an accumulation process that combines data from multiple radar frames over time to enhance the detectability of targets and reduces the effects of noise and interference. Frame accumulation typically involves summing or averaging radar data sets across these radar frames, which tends to cancel or diminish random noise and emphasize consistent signals. In some embodiments, this combination may be performed by simply summing or averaging the radar returns of a certain number of most recently generated radar frames. In another embodiment, this combination may be performed by passing the pre-processed data through an infinite impulse response (IIR) filter, or an IIR-like frame accumulator that effectively allows previous radar frames to influence the current output. In some embodiments, the IIR-like frame accumulator may use decay factors that adjust the influence of older radar frames relative to more recent radar frames.

At block 734, the accumulated pre-processed data may be filtered by an adaptive Weiner filter similar to what is described above with respect to block 712 and equation (1). However, here, ƒ[n] is the accumulated pre-processed data (e.g., fourth radar data set) of the current radar frame and ƒ[n-1] is the accumulated pre-processed data of the previous radar frame (e.g., fifth radar data set). The processing logic may generate accumulated filtered data at block 734. Also similar to block 712, a residual clutter mask may be used to filter the accumulated pre-processed data. In at least some embodiments, the processing logic may also use a band pass filter on at least low range bins (e.g., range bins closest to the wireless device) and high range bins (e.g., range bins furthest from the wireless device). This band pass filter may be designed to reduce or eliminate noise from device vibration (low range bins) and multipath (high range bins). In at least some embodiments, this band pass filter may also reduce reflected signals that reflect from objects behind a wall (high range bins).

At block 736, similar to block 714, one or more candidate peak values may be identified within the accumulated filtered data. These candidate peak values may represent magnitude values. Range bins corresponding to these candidate peak values may be identified and sent to block 738, where the processing logic may identify peak thresholds corresponding to each of these range bins. Additionally, the processing logic may optionally calculate statistics (e.g., “batch” statistics) of the accumulated filtered data. These statistics may include, but are not limited to peak width measurements, peak prominence (e.g., how significant is a particular peak in view of historical batch radar data), and peak height. These statistics may also be sent to block 738.

At block 738, the processing logic identifies a peak threshold for each range bin identified at block 736, similar to the operations of the processing logic at block 716. Additionally, the processing logic identifies statistical thresholds that may be compared to the calculated statistics of the accumulated filtered data. These peak value and statistical thresholds may be compared to the candidate peak values and calculated statistics of the accumulated filtered data at block 740. The peak thresholds for the static pipe 730 may be determined using historical radar data. In some embodiments, these peak thresholds for the static pipe 730 may be based on a constant false alarm rate (CFAR), cell averaging (CA), or ordered statistics (OS) approach to thresholding for static detection. In at least one embodiment, these peak thresholds for the static pipe 730 may be dynamic and take into account previous radar frame(s). In some embodiments, the peak thresholds of the dynamic pipe 710 may generally be higher than the peak thresholds used by the static pipe 730, as the dynamic pipe 710 is designed to detect greater amounts of movement than the static pipe 730. In other embodiments, the peak thresholds of the dynamic and static pipes 710, 730 may be the same or similar.

At block 740, if at least one of these candidate peak values of the accumulated filtered data satisfies their respective peak threshold, the processing logic may indicate that static presence of a target has been detected. If none of these candidate peak values satisfy their respective peak thresholds, the processing logic may indicate that static presence of a target has not been detected (or, in an alternative embodiment, simply fail to indicate that static presence of a target has been detected).

At block 742, a moving average filter may be updated using one or more of the candidate peak values, the calculated statistics, or the indication generated at block 740. This moving average filter, as used by the processing logic, may track how many radar frames within a sliding window have at least one candidate peak value that satisfies its respective peak threshold. This sliding window may include any number of multiple radar frames. The moving average filter may output a value. This value may be a percentage (e.g., 3 of 5 radar frames have a candidate peak value that satisfies its respective peak threshold, or 60%) or the number of radar frames within the sliding window that have a candidate peak value that satisfies its respective peak threshold.

At block 744, the processing logic may compare the value outputted by the moving average filter to a second threshold number of radar frames. As long as the value satisfies the second threshold number of radar frames, the processing logic may determine that a static presence is detected (e.g., presence flag indicates presence) and determine a range estimate of at least one candidate peak value of the accumulated filtered data. Once the value no longer satisfies this second threshold, the processing logic may determine that a static presence is no longer detected. In other words, if the processing logic determines that at least the second threshold number of radar frames within the sliding window has respective peak values that each satisfy respective static peak thresholds, the processing logic determines that a static presence of the target has been detected. Conversely, if the sliding window does not have at least the second threshold number of radar frames that have respective peak values that each satisfy their respective static peak thresholds, then the processing logic detects an absence of the target.

In some embodiments, the range estimate may be based on the range bin of the candidate peak value closest to the wireless device that satisfies its respective peak threshold. For example, if a first candidate peak value around one meter from the wireless device and a second candidate peak value around two meters from the wireless device each satisfy their respective peak thresholds, the processing logic may determine one meter as the range estimate. In other embodiments, the range estimate may be based on the range bin of the candidate peak value with the highest magnitude value of the filtered data that satisfies its respective peak threshold. Operations of the processing logic at block 704 described above may be based on the resulting indication of static presence (e.g., maintaining the presence flag as enabled or disabling the presence flag) from the static pipe 730 at block 744.

FIG. 8 is a flowchart depicting a finite state machine (FSM) 800 switching between a dynamic mode 802 and a static mode 804, according to one embodiment. The FSM 800 may be part of the presence detection logic 126. The FSM 800 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the FSM 800 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the FSM 800. The FSM 800 can be performed by other devices described herein.

The FSM 800 may contain at least two modes: a dynamic mode 802, and a static mode 804. In some embodiments, while the FSM 800 is in the dynamic mode 802, the processing logic may utilize the dynamic pipe 710 of FIG. 7 to determine whether an ingress has been detected (e.g., whether a target has entered the FOV of the radar operations of the wireless device). While the FSM 800 is in the static mode 804, the processing logic may utilize the static pipe 730 of FIG. 7 to determine whether a static presence of the target is detected. Thus, in one embodiment, only one of the dynamic pipe 710 and the static pipe 730 may be utilized per radar frame. In other embodiments, the dynamic pipe 710 and static pipe 730 may be utilized for each radar frame regardless of the mode of the FSM 800.

The finite state machine may wait in dynamic mode 802 until a dynamic presence is detected. Per the description above with respect to the dynamic pipe 710, dynamic presence may be detected if a first number of consecutive radar frames with a candidate peak value satisfying its respective dynamic peak threshold have been tracked by the processing logic. This dynamic presence may be an ingress by a target into the FOV of the radar operations of the wireless device. Once the dynamic presence is detected, the processing logic may enable a presence flag that is used by other applications to cause the wireless device to perform one or more actions related to the presence detection.

The FSM 800 may remain in dynamic mode 802 until a radar frame is received that does not have a candidate peak value that satisfies its respective dynamic peak threshold. In other words, the FSM 800 may remain in dynamic mode 802 until the consecutive radar frames having candidate peak values that satisfy their respective dynamic peak thresholds ends. Once this radar frame is received, the FSM 800 may switch to static mode 804 that keeps the presence flag enabled as long as a second threshold number of radar frames within a sliding window have a candidate peak value that satisfies its respective static peak threshold. This sliding window may include the current radar frame and a certain number of previous radar frames (e.g., 5 radar frames total, 10 radar frames total, or the like). Once static presence is no longer detected (e.g., less than the second threshold number of radar frames within the sliding window have a candidate peak value that satisfies its respective static peak threshold), absence of the target is confirmed by the FSM 800, the presence flag is disabled, and the FSM 800 returns to dynamic mode 802 to await the next dynamic presence detection.

In some embodiments, the dynamic mode 802 may have a higher frame per second (FPS) rate than the static mode 804, meaning that, when the FSM 800 is in dynamic mode 802, the wireless device may go through more radar operation cycles per second than while the wireless device is in static mode 804. This may be possible because, while in dynamic mode 802 (or at least during absence), the wireless device may not be actively communicating with other wireless devices, leaving more airtime as available for radar detection. This higher FPS while in dynamic mode 802 may also help lower a latency of determining dynamic presence of a target. For example, if the wireless device generated 10 radar frames per second (e.g., 10 FPS) during an absence period (e.g., before dynamic presence is detected), the dynamic presence of a target could be determined much faster than if the wireless device generated 1 radar frame per second (e.g., 1 FPS) during an absence period.

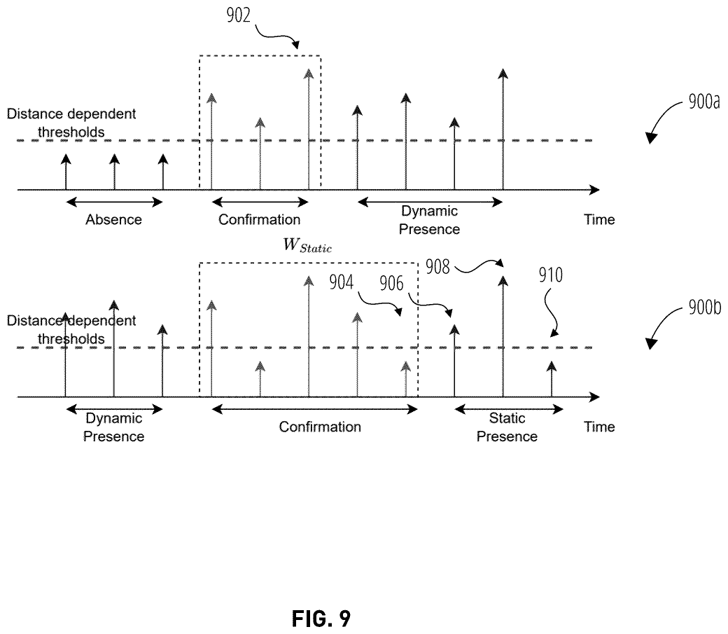

FIG. 9 illustrates a decision-making process of the FSM 800, according to one embodiment. Each upwards-pointing arrow represents candidate peak value(s) of radar frames, while the dotted lines represent peak thresholds (distance dependent thresholds) corresponding to those candidate peak values. For sake of simplicity, the upwards-pointing arrows compared to the peak thresholds of the graphs 900a, 900b is meant to show whether a particular radar frame has a candidate peak value that satisfies its respective dynamic or static peak threshold, depending on the mode of the FSM 800.

The first graph 900a depicts a scenario where a dynamic presence is detected by the FSM 800. In this particular scenario, the FSM 800 may require at least three consecutive peak values to confirm dynamic presence of a target. At a first radar frame 902, the FSM 800 may have tracked three consecutive radar frames having a candidate peak value that satisfies its respective dynamic peak threshold. Thus, the radar frames following the first radar frame 902 may be labeled as a dynamic presence until a radar frame is received that does not have a candidate peak value that satisfies its respective dynamic peak threshold.

The second graph 900b depicts a scenario where the FSM 800 switches from dynamic mode 802 to static mode 804. In some embodiments, to switch from dynamic to presence mode, a radar frame must first be received that does not have a candidate peak value that satisfies its respective dynamic peak threshold. Any of the radar frames within the sliding confirmation window may be this radar frame, as illustrated, because the FSM 800 is no longer in dynamic presence. However, this graph does not indicate which of these radar frames caused the FSM 800 to switch from dynamic mode 802 to static mode 804. In static mode, static presence of the target is confirmed if a second threshold number of radar frames within a sliding window (e.g., sliding confirmation window) have a candidate peak value that satisfies its respective static peak threshold. In the scenario depicted by second graph 900b, this second threshold number of radar frames may be three, while the sliding window may include five radar frames (e.g., a current radar frame, which is a second radar frame 904 here, and four previous radar frames). Here, static presence of the target may be confirmed at the second radar frame 904 because three radar frames within the sliding window have at least one candidate peak value that satisfies its respective peak threshold. Likewise, as the sliding window moves to a third radar frame 906, a fourth radar frame 908, and a fifth radar frame 910, the static presence of the target is confirmed because the sliding window for each of these radar frames will include at least three radar frames that have a candidate peak value that satisfies its respect peak threshold.

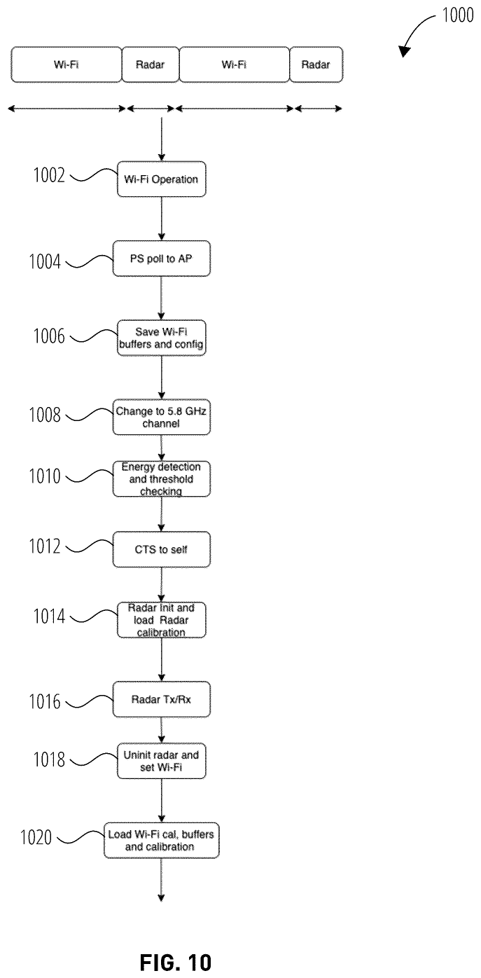

FIG. 10 is a flowchart illustrating a co-existence protocol 1000 that switches between a radio mode and a radar mode, according to one embodiment. A radio mode may be a first portion of a time window when wireless communication operations are performed. A radar mode may be a second portion of the time window when radar operations are performed. The radio and radar modes may occur sequentially within this time window, and be mutually exclusive. In some embodiments, the switching between radio and radar modes may cause the processing logic to be inoperable for a short period of time. Any period of time short enough to avoid impacting the wireless communication operations of the wireless device may be desired. The co-existence protocol 1000 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the processing logic may be the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the co-existence protocol 1000. The co-existence protocol 1000 can be performed by other devices described herein.

At block 1002, the processing logic may perform Wi-Fi® operation(s) within the radio mode. The Wi-Fi® operation(s) may include communicating with another wireless device by sending or receiving data packets over a channel.

At block 1004, the processing logic may send a power save (PS) poll to an access point (AP). The PS poll may indicate to the AP that the processing logic will temporarily not receive any data packets sent by the AP. The AP may store data packets intended for the processing logic until the processing logic indicates to the AP that it is again able to receive data packets. The processing logic may not indicate an active mode to the AP until after saved Wi-Fi® data and configuration(s) are reloaded to the processing logic at block 1020.

At block 1006, the processing logic may save Wi-Fi® data and configuration(s). The processing logic may store the Wi-Fi® data and configuration(s) by storing them in memory external to the TX or RX chains to ensure that critical information like network credentials, connection parameters, and temporary network data is preserved while the processing logic switches from the radio mode to the radar mode. The saved Wi-Fi® configuration(s) may include a first set of parameters designed for transmitting and receiving RF signals for RF communications. For example, the first set of parameters may control a power output of an orthogonal frequency-division multiplexing (OFDM) signals used for transmitting and receiving RF signals for RF communications.

At block 1008, the processing logic may change a channel. For example, during radio mode, the processing logic may wirelessly communicate with surrounding wireless devices part of a wireless local area network (WLAN) using typical channels (e.g., channels 1, 6, and 11 of the 2.4 GHz band). However, due to considerable amounts of wireless communication traffic in these channels, radar operations may not be optimized if performed on these same typical channels. As such, the processing logic may switch to a channel not typically used for wireless communication (e.g., 5.8 GHz channel, or channel 160 of the 5 GHz band) when switching from the radio mode to the radar mode. Additionally, a bandwidth of a channel used during radio mode may not be the same as a bandwidth of a channel used during radar mode.

At block 1010, before initializing the radar mode and loading the radar calibration(s), the processing logic may verify whether a high energy signature is observed by a receive (RX) antenna (e.g., RX antenna, the second antenna 1224) within the frequency channel selected by the processing logic at block 1008. If a high energy signature is observed, the processing logic may repeatedly verify the energy signature observed by the RX antenna until the energy signature is below a threshold (e.g., satisfies the threshold). In at least some embodiments, this threshold may be set at between −60 and −65 decibel milliwatts (dBm). In some embodiments, if the threshold is not satisfied, the processing logic may repeatedly verify the energy signature observed by the RX antenna until the second portion of the time window has expired. Once the time window has expired, the processing logic may revert back to the radio mode and load the Wi-Fi® data and calibration(s) at block 1020 until the first portion of a subsequent time window has expired (e.g., until the next time the processing logic is to switch from the radio mode to the radar mode).

At block 1012, the processing logic may initialize a clear to send (CTS) signal that is sent to itself. The CTS signal may be sent in order to initialize the radar mode.

At block 1014, the processing logic initializes the radar mode and loads the radar calibration(s). The radar calibration(s) loaded may include a second set of parameters that can be determined and used for radar functionality. The second set of parameters can be calibration values for RF front-end calibration, gain and phase calibration, in-phase and quadrature (IQ) imbalance calibration, pre-distortion calibration, carrier frequency calibration, antenna calibration, time alignment calibration, direct current (DC) offset calibration, temperature compensation, or the like. In at least one embodiment, the first set of parameters (e.g., radio mode parameters) has a first parameter that indicates a first transmit power level of the TX chain, and the second set of parameters (e.g., radar mode parameters) has a second parameter that indicates a second transmit power level of the TX chain. In another embodiment, the first set of parameters includes a first parameter that indicates a first calibration value of a component of the TX chain or the RX chain, and the second set of parameters includes a second parameter that indicates a second calibration value of the component.

At block 1016, the processing logic performs one or more radar operations. Each radar operation may include (i) transmitting an RF signal including a set of chirps and (ii) receiving reflected signals including a reflected set of chirps corresponding to the set of chirps of the RF signal. Additionally, each radar operation may also include generating digital values indicative of a presence or movement of a person or other object within the field of view of antenna(s) coupled to the processing logic.

At block 1018, the processing logic initiates a switch back to the radio mode from the radar mode.

At block 1020, the processing logic reloads the Wi-Fi® data and configuration(s) store at block 1006.

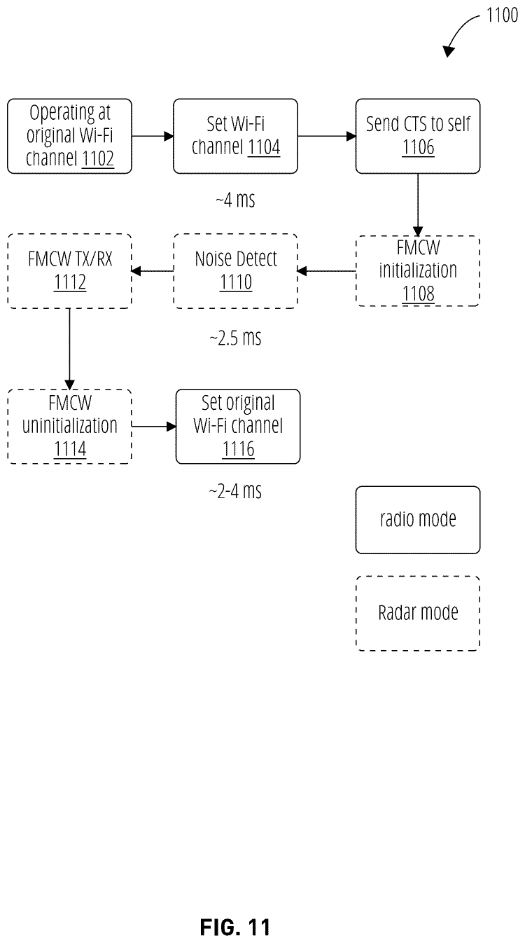

FIG. 11 is a flowchart illustrating a co-existence protocol 1100 with radio and radar modes, according to one embodiment. A radio mode may be a first portion of a time window when wireless communication operations are performed. Operations of the co-existence protocol 1100 that correspond to the radio mode may be encapsulated by a solid line. A radar mode may be a second portion of the time window when radar operations are performed. Operations of the co-existence protocol 1100 that correspond to the radar mode may be encapsulated by a dotted line. The co-existence protocol 1100 may switch between operational cycles of the radar and radio modes. The radar operations that occur between (i) switching from radio mode to radar mode and (ii) switching back to radio mode from radar mode may be referred to as an operational cycle of the radar mode.

In some embodiments, while a wireless device is in radar mode or is switching between radio and radar modes, the wireless device may not be able to communicate with other wireless devices on the same network. Thus, minimizing an amount of time in radar mode or switching between radio and radar modes may be desired. The co-existence protocol 1100 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the processing logic may be the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the co-existence protocol 1100. The co-existence protocol 1100 can be performed by other devices described herein.

At block 1102, the processing logic may perform Wi-Fi® operation(s) within the radio mode. The Wi-Fi® operation(s) may include communicating with another wireless device by sending or receiving data packets over a channel.

At block 1104, the processing logic may change a channel. For example, during radio mode, the processing logic may wirelessly communicate with surrounding wireless devices part of a wireless local area network (WLAN) using typical channels (e.g., channels 1, 6, and 11 of the 2.4 GHz band). However, due to considerable amounts of wireless communication traffic in these channels, radar operations may not be optimized if performed on these same typical channels. As such, the processing logic may switch to a channel not typically used for wireless communication (e.g., 5.8 GHz channel, or channel 160 of the 5 GHz band) when switching from the radio mode to the radar mode. Additionally, a bandwidth of a channel used during radio mode may not be the same as a bandwidth of a channel used during radar mode. In at least one embodiment, setting this channel may take approximately 4 milliseconds (ms).

At block 1106, the processing logic may initialize a clear to send (CTS) signal that is sent to itself. The CTS signal may be sent in order to initialize the radar mode.

At block 1108, the processing logic may initialize the radar mode (e.g., FMCW) by loading a set of parameters that calibrate the wireless device for radar operations. This set of parameters can be calibration values for RF front-end calibration, gain and phase calibration, in-phase and quadrature (IQ) imbalance calibration, pre-distortion calibration, carrier frequency calibration, antenna calibration, time alignment calibration, DC offset calibration, temperature compensation, or the like.

At block 1110, the processing logic may verify whether a high energy signature is observed by an antenna (e.g., the second antenna 1224) within the frequency channel selected by the processing logic at block 1008. If a high energy signature is observed, the processing logic may repeatedly verify the energy signature observed by the antenna until the energy signature is below a threshold (e.g., satisfies the threshold). In at least some embodiments, this threshold may be set at between −60 and −65 decibel milliwatts (dBm). In some embodiments, if the threshold is not satisfied, the processing logic may repeatedly verify the energy signature observed by the antenna until the second portion of the time window has expired. In some embodiments, once the portion of the time window apportioned for the radar mode has expired, regardless of whether radar signals were sent and received, the processing logic may revert back to the radio mode and load radio parameters and calibration(s). In some embodiments, the processing logic may take approximately 2.5 ms to verify the energy signature.

At block 1112, the processing logic performs one or more radar operations. Each radar operation may include (i) transmitting an RF signal including a set of chirps and (ii) receiving reflected signals including a reflected set of chirps corresponding to the set of chirps of the RF signal. Additionally, each operational cycle of the radar mode may also include generating digital values indicative of a presence or movement of a person or other object within the field of view of antenna(s) coupled to the processing logic.

At block 1114, the processing logic may uninitialize the radar mode (e.g., FMCW) and revert back to radio mode.

At block 1116, the processing logic may reload the radio data and configuration(s) and restore radio operations on the original channel of block 1102.

FIG. 12 is a block diagram of a wireless device 1200 with a baseband processor 1202 with integrated radio and radar functionality, according to one embodiment. The wireless device 1200 includes the baseband processor 1202, a local oscillator (LO) 1212, a first mixer 1214, a Wi-Fi transmission (TX) chain 1216, a first antenna 1218 (e.g., TX antenna), a second mixer 1220, an RX chain 1222, and a second antenna 1224 (e.g., RX antenna). The baseband processor 1202 can be a wireless chipset coupled to a host device.

In at least one embodiment, the baseband processor 1202 is a System on Chip (SoC) that manages, among other things, the wireless protocol of a radio and possibly other aspects of the behavior and operation of the wireless device 1200. The wireless device 1200 can also include a host processor that controls the operations of the baseband processor 1202 and other operations of the wireless device 1200. The baseband processor 1202 can control radio operations to communicate with one or more devices over one or more communication links. The baseband processor 1202 can implement the Wi-Fi® technology, the Bluetooth® technology, or both. Alternatively, the baseband processor 1202 can implement other radio technologies. The baseband processor 1202 can be any type of processing device, such as a digital signal processor (DSP), an application-specific integrated circuit (ASIC), a field-programmable gate array, or any other type of processing device with radio functionality. In at least one embodiment, the baseband processor 1202 can include radio logic 1204 and radar logic 1206. The radio logic 1204 can be a radio subsystem of the baseband processor 1202 and the radar logic 1206 can be a radar subsystem of the baseband processor 1202. In some embodiments, the radar logic 1206 can include a chirp generator 1208 and dechirping logic 1210.

In at least one embodiment, the baseband processor 1202 is coupled to the first antenna 1218. The baseband processor 1202 can drive the first antenna 1218 using one or more radio frequency (RF) signals in an RF path, including at least the Wi-Fi TX chain 1216. A current flow on the RF path can induce current on the first antenna 1218 to cause the first antenna 1218 to radiate electromagnetic energy. The baseband processor 1202 can also receive RF signals, received as electromagnetic energy by a second antenna 1224, in an RF path, including at least the RX chain 1222. In some embodiments, the RX chain 1222 can be a dedicated RX path for radar operations and a separate RX chain can be used for receiving other RF signals, such as wireless communications sent to the wireless device 1200. In other embodiments, the RX chain 1222 may be configured to both receive RF signals for both wireless communication operations and radar operations. In some cases, the RF signals are received on the same first antenna 1218. The first antenna 1218 and the second antenna 1224 can be any type of antenna, such as a monopole, a loop, a patch, a slot, or the like. The baseband processor 1202 can cause the first antenna 1218 and second antenna 1224 to radiate and receive electromagnetic energy in a specified frequency range, such as the 2.4 GHz frequency band for wireless personal area network (WPAN) applications (e.g., Bluetooth® Classic or Bluetooth® Low Energy (BLE) technology), wireless local area network (WLAN) applications (e.g., Wi-Fi® technology), or the like. In one embodiment, an operating frequency of the baseband processor 1202 is a wide area network (WAN) frequency band (e.g., 5G, Long Term Evolution (LTE) technology, or the like).

During operation, the baseband processor 1202 can establish a wireless connection 1226 with a second wireless device 1228 over a channel using a wireless local area network (WLAN) protocol (e.g., Wi-Fi® protocol). The radar logic 1206 can be a radar unit that is integrated in the same integrated circuit as the radio logic 1204. The radio logic 1204 implements the radio functionality of the wireless device 1200 for communicating with other wireless devices, including the second wireless device 1228. The radar logic 1206 implements the radar functionality of the wireless device 1200 for presence and localization operations described herein.

In at least one embodiment, the first mixer 1214, the Wi-Fi TX chain 1216, the LO 1212, the second mixer 1220, and the RX chain 1222 can be part of radio frequency front-end (RFFE) circuitry. The Wi-Fi TX chain 1216 can include components involved in generating and transmitting radio frequency (RF) signals. The Wi-Fi TX chain 1216 can be calibrated to ensure accurate and reliable signal transmission. For example, the Wi-Fi TX chain 1216 can include power amplifiers, filters, and frequency synthesizers. Calibrating the TX chain helps ensure accurate and reliable signal transmission for either wireless communication or radar operations. A first set of parameters can be determined and used for transmitting and receiving RF signals for RF communications. For example, the first set of parameters may control a power output of an orthogonal frequency-division multiplexing (OFDM) signals used for transmitting and receiving RF signals for RF communications. A second set of parameters can be determined and used for radar functionality as described in more detail below. The second set of parameters can be calibration values for RF front-end calibration, gain and phase calibration, in-phase and quadrature (IQ) imbalance calibration, pre-distortion calibration, carrier frequency calibration, antenna calibration, time alignment calibration, direct current (DC) offset calibration, temperature compensation, or the like. Calibration in the Wi-Fi TX chain 1216 is typically performed during a manufacturing process or periodically during operation to maintain system performance over time. It is crucial for meeting regulatory requirements, achieving high-quality communication, and minimizing interference with other wireless systems. Calibration algorithms and methods may vary depending on the specific communication technology and system design.

In some embodiments, the RFFE circuitry can include a digital-to-analog converter (DAC) that can convert digital signals to output analog signals for RF transmissions via the first antenna 1218. Similarly, the RFFE circuitry can include an analog-to-digital converter (ADC) that can convert input analog signals into digital signals for processing by the baseband processor 1202.

In at least one embodiment, since the radar logic 1206 is integrated in the baseband processor 1202, the Wi-Fi TX chain 1216 can be reused for radar transmissions. In particular, the baseband processor 1202 can generate second digital values representing a first baseband signal. The second digital values may be converted into the first baseband signal by a digital-to-analog converter (DAC) (not illustrated in FIG. 12). In some embodiments, the first baseband signal may be a a frequency modulated continuous wave (FMCW) signal that includes a set of chirps. While many types of radar signals may potentially be implemented, FMCW may chosen due to low complexity and overall compatibility with the existing radio hardware designed for Wi-Fi® operations. In other embodiments, the transmitted RF signal may be another type of RF signal used in radar operations, such as pulse radar, pulse-doppler radar, synthetic aperture radar (SAR), bistatic and multistatic radar, monopulse radar, or the like. The first baseband signal may be combined with an LO signal generated by the LO 1212 by the first mixer 1214. The resulting mixed signal may be an RF signal that is based on both the LO signal and the first baseband signal. The RF signal may be transmitted through the first antenna 1218 into the surrounding environment. The RF signal may be transmitted via the Wi-Fi TX chain 1216 and first antenna 1218 in a first portion of a frame having a specified frame duration. The transmitted RF signal propagates through space and may encounter various objects (targets) along its path, such as a person. When the transmitted RF signal encounters an object, a portion of the signal is reflected back toward the wireless device 1200.

While the first antenna 1218 transmits the RF signal, the second antenna 1224 may be listening (e.g., observing, receiving) for reflected signals that correspond to the RF signal. The reflected signals may be the RF signal after reflecting off an object or objects (e.g., a person, a car, or another target). The second antenna 1224 may provide the reflected signals to the RX chain 1222. In at least one embodiment, the RX chain 1222 can be a dedicated RX chain for receiving reflected signals from the radar transmissions for presence and localization. In another embodiment, the RX chain 1222 may be used for both receiving radio transmissions and radar transmissions. The RX chain 1222 may include one or more signal processing hardware components, such as a low noise amplifier (LNA). In some embodiments, the RX chain 1222 includes a wideband filter to reduce out-of-band Wi-Fi interference. The RX chain 1222 may provide the reflected signals to the second mixer 1220. The second mixer 1220 may extract a second baseband signal from the reflected signals by mixing the reflected signals with the LO signal. The second baseband signal may be provided to an analog-to-digital converter (ADC) not illustrated in FIG. 12), which converts the second baseband signal into third digital values. The third digital values may be provided to the baseband processor 1202, and more particularly, to the dechirping logic 1210. The dechirping logic 1210 may use the second digital values and the third digital values to generate first digital values. The dechirping logic 1210 may digitally mix the second digital values and the third digital values to generate first digital values representing a beat signal, which may represent the difference between the first baseband signal (e.g., original set of chirps) and the second baseband signal (including the reflected set of chirps). The beat signal may include a frequency that is proportional to the time delay (At) between the transmitted and reflected signals, which is caused by the round-trip propagation time of the chirp. The time delay (Δt) can be related to the physical distance (d) to the target through the formula: d=c*Δt/2, where c is the speed of light. The beat frequency may be indicative of a phase difference between the first baseband signal (represented by the second digital values) and the second baseband signal (represented by the third digital values). By measuring the beat frequency, the radar unit can determine the distance to the target. In some cases, the FMCW radar unit can also detect a Doppler shift caused by moving targets. If a target is moving towards or away from the radar, the reflected signal may experience a frequency shift. By analyzing the frequency shift of the reflected signal, the radar unit can determine the velocity of the target relative to the radar unit. As such, the first digital values may be indicative of a presence or movement of a person or other object in range of the wireless device 1200.

In some embodiments, the first digital values, second digital values, and third digital values may be a representations (e.g., logarithmic representations) of at least a portion of their respective analog signals (e.g., baseband signals). In other embodiments, the first digital values, second digital values, and third digital values may be IQ samples (or an in-phase sample or a quadrature sample).

In at least one embodiment, the radio logic 1204 and radar logic 1206 are integrated in a Wi-Fi® chipset. In at least one embodiment, the radar logic 1206 is an FMCW radar unit. FMCW is a type of radar system that uses continuous transmission of frequency-modulated signals to detect and measure the physical distance to objects. The FMCW radar unit may generate a continuous waveform known as a “chirp.” A chirp is a signal that continuously changes frequency over time. The frequency of the chirp increases or decreases linearly with time during each transmission. The chirp waveform typically has a frequency sweep bandwidth (B) and a chirp duration (T). The rate of frequency change (slope) is calculated as the ratio of the bandwidth to the chirp duration (Slope=B/T). The chirp may be generated by the chirp generator 1208. In various embodiments, a memory coupled to the chirp generator 1208 may store multiple sets of values that each correspond to different chirps of varying bandwidths or durations. In some embodiments, the memory coupled to the chirp generator 1208 may store chirps of different shapes or types (e.g., exponential, quadratic, step, hyperbolic, or sawtooth). The memory coupled to the chirp generator 1208 may be one or more sets of registers or another memory device. The memory coupled to the chirp generator 1208 may be configured for either short or long-term storage. Before generating the second digital values, a set of values corresponding to a desired chirp may be programmed into a programmable buffer (e.g., circular buffer) that employs a rotating index that moves around the buffer to repeatedly access and provide the set of values in a continuous, cyclical manner. By employing the rotating index, the programmable buffer allows chirp generator 1208 to repeatedly provide the same chirp over and over within a time window (e.g., the first portion of the frame). In other words, the rotating index allows the chirp generator 108 to provide multiple instances of the same chirp using only enough space on the buffer to store digital values (e.g., IQ samples or other digital values) to store one chirp. The programmable buffer may be implemented in software, firmware, hardware, or any combination thereof.

The slope of the desired chirp may be dependent on a total number of values within the corresponding set of values. For example, a first set of values representing a first chirp having a bandwidth of 150 MHz and a duration of 4 milliseconds (ms) may include twice the number values than a second set of values representing a second chirp having a bandwidth of 150 MHz and a duration of 2 ms.

In at least one embodiment, the wireless device 1200 includes a processing device 1230 coupled to the baseband processor 1202. The processing device 1230 can receive the first digital values from the radar logic baseband processor 1202. The processing device 1230 can determine, using the first digital values, that an environment in which the wireless device 1200 is located has been disrupted by a presence or motion of a person or other object. This presence detection may be performed using the presence detection logic 126 described above with respect to FIGS. 1-8. The processing device 1230 can determine, using the first digital values, a presence of a user in proximity to the wireless device 100. The processing device 1230 and how the first digital values are used to determine that the environment has been disrupted by a presence or motion of a person or other object is described in more detail below with respect to FIG. 2.

The presence can be used for subsequent operations by the device, such as operations of an ambient mode. Radar capability on the existing wireless connectivity solution can provide credible presence and location information with minimal additional costs and creates opportunities for sensor fusion with other modalities. The first digital values from the radar logic 1206 could be a viable alternative for enabling certain features or modes on low-end devices, such as smart mode or ambient mode. This integrated radar logic 1206 can enable these certain features or modes on the wireless device 1200 without the need for any additional sensors. In at least one embodiment, the baseband processor 1202 sends RF signals generated by both the radar logic 1206 and radio logic 1204 over the same channel. In another embodiment, the baseband processor 102 sends the RF signals generated by the radar logic 1206 in a first channel of a frequency band and sends or receives RF signals generated by the radio logic 1204 in a second channel of the frequency band, where the first channel and the second channel are different.

The radar logic 1206 (FMCW radar unit) can function in a time-sharing fashion with the radio logic 1204. By time-sharing the radar functionality and the radio functionality on the same channel (or a different channel in the frequency band), the host processor can switch between (i) Wi-Fi® (or another type of wireless communication) operations, such as sending and receiving data packets, and (ii) radar operations to determine the presence and localization information to detect presence of a person and determine a physical distance to the person for detection and localization applications. The radio logic 1204 and radar logic 1206 can be implemented in a Wi-Fi® and Radar co-existence protocol that is designed in a way that it does not impact any of the existing Wi-Fi® standard along with Wi-Fi® use-cases. This co-existence protocol is explained in more detail below with respect to FIG. 10. It should be noted that off-the-shelf Wi-Fi® chips do not have dedicated radar functionality. For these chips, only channel state information (CSI) based sensing is feasible. However, with the radar logic 1206 integrated into the Wi-Fi® chipset, the wireless device 1200 can use one or more of a radar mode or CSI mode to detect a presence of a person and determine a distance to the person for detection and localization applications. In some embodiments, the inclusions of the radar functionality and sensor fusion algorithms, as described herein, with CSI data, can enable new use cases and improve accuracy of existing use cases.

While the wireless device 1200 as described above is configured for person detection, the wireless device 1200 may be used in a number of different environments. For example, in some embodiments, the wireless device 1200 may be used to provide a sensing capability for an automobile that determines position and velocity of other automobiles or objects nearby. In these embodiments, the radio logic 1204 may provide Bluetooth® or Wi-Fi® connectivity within the automobile while the radar logic 1206 provides the sensing capability. Other use cases where the present disclosure may be implemented may include, but is not limited to, security applications (e.g., doorbell cameras or other motion detection devices), geofencing (e.g., triggering certain actions or location services based a boundary and a location of an object or person), or other applications that utilize radar or passive infrared (PIR) to detect motion or presence of an object or person.

FIG. 13 is a block diagram of a wireless device 1300 with a chirp generator 1208 and digital dechirping logic 1210, according to one embodiment. The wireless device 1300 may include features that are the same or similar to the wireless device 1200 as described above with respect to FIG. 12. The wireless device 1300 includes at least the chirp generator 1208, a DAC 1302, the first mixer 1214, the LO 1212, a power amplifier 1306, the first antenna 1218, the second antenna 1224, an LNA 1308, the second mixer 1220, an ADC 1304, and a digital dechirping logic 1310. The digital dechirping logic 1310 may include same or similar features to the dechirping logic 1210. The chirp generator 1208, the DAC 1302, the first mixer 1214, the LO 1212, the power amplifier 1306, the first antenna 1218 may form a TX chain. The the second antenna 1224, the LNA 1308, the second mixer 1220, the ADC 1304, and the digital dechirping logic 1310 may form an RX chain.

In some embodiments, as already described, the chirp generator 1208 may generate a set of chirps—i.e., a signal that continuously changes frequency over time. The chirp generator 1208 may be configured to provide second digital values representing the set of chirps as an FMCW signal. The chirp generator 1208 may provide the first digital values to the DAC 1302 by employing a programmable buffer with a rotating index, as described above with respect to FIG. 12.

In some embodiments, a power characteristic of the FMCW signal may be different than a signal strength of an orthogonal frequency-division multiplexing (OFDM) signal used during wireless communication. For examples, the OFDM signal may inherently have a high peak-to-average power ratio (PAPR). However, FMCW signals are often employed in radar systems and have a different waveform than OFDM signals. In FMCW, the signal's frequency varies with time to measure the range and velocity of objects with the field of view (FOV) of the radar unit (e.g., the wireless device 1300). As such, FMCW signals generally have lower PAPR when compared to OFDM signals because the FMCW itself, which involves a continuous change in frequency over time, generally does not lead to the same peak power characteristics seen in OFDM where the superposition of multiple sub-carrier signals can align to create high peak power. While OFDM and FMCW signals may not have the same PAPR or peak power characteristics, power characteristics of OFDM and FMCW signals may be related by one or more offset power values. As such, the chirp generator 1208 may utilize a first look-up table (LUT) including offset values (e.g., offset power values) that represent a difference between FMCW power levels and OFDM power levels. Each of these offset values may correspond to a frequency or frequency range. The offset values may be determined by comparing historical FMCW and OFDM power levels. These offset values may be used to determine what power level an FMCW signal should have at a particular frequency or point in time. In various embodiments, the offset values are a difference between historical FMCW and OFDM power levels at a frequency or frequency range.

At any given frequency, the chirp generator 1208 may generate the FMCW signal by combining the OFDM power value and the corresponding offset value from the first LUT.

In some cases, the wireless device 1300 may be deployed in an environment with a high noise floor. The high noise floor may be caused by wireless communication traffic within the bandwidth of the set of chirps, the inherent nature of higher frequencies, multipath, considerable amounts of clutter or the like. So, due to the high noise floor, a high overall signal strength of chirps transmitted by the TX chain may be desired. However, the overall signal strength each chirp may be limited due to leakage (e.g., direct transmission) between the first antenna 1218 and the second antenna 1224. The leakage may occur due to a lack of full isolation between the first antenna 1218 and the second antenna 1224. Thus, to avoid the ADC 1304 saturating (e.g., the reflected signals being clipped by the ADC 1304) due to the leakage, the signal strength of the FMCW signal may be limited. The signal strength of the FMCW signal may also be limited by a higher bandwidth of the reflected signal converted to digital values by the ADC 1304 than a bandwidth of the originally transmitted chirp signal. This higher bandwidth may introduce a higher noise floor into the reflected signal, which may cause the signal strength of the FMCW signal to be lower to avoid saturating the ADC 1304. The signal strength of the FMCW signal may also be limited because the Wi-Fi TX chain 1216 is primarily configured for wireless communication, not radar operations. Thus, while a high signal-to-noise ratio (SNR) may be desired, the above problems (and other similar problems) may pose a challenge to raising the SNR of the wireless device 1300.

These problems and others may be solved by increasing a number of chirps within the FMCW signal and coherently integrating reflected chirps corresponding to the transmitted chirps. Coherent integration involves summing the reflected chirps coherently (i.e., maintaining the phase information) over multiple pulses or chirps. By averaging the signals, coherent integration enhances the reflected chirps while canceling or reducing noise (e.g., random noise). This results in an improved SNR, making it easier to detect and analyze reflected chirps against the background noise. Thus, a higher number of chirps transmitted and reflected by the wireless device 1300 positively correlates with a higher SNR. As such, due to the properties of coherent integration, the SNR of the reflected signals (e.g., as described above with respect to FIG. 12) may depend on a total number of chirps within the overall FMCW signal. For example, a first FMCW signal including twenty chirps over a time window will have a higher SNR than a second FMCW signal including ten chirps over the same time window. Under the same assumption, a high number of chirps within the FMCW signal may be desired to improve SNR, which in turn improves presence detection of the wireless device 1400.

While a high bandwidth may also improve SNR, the bandwidth of each chirp may be compliance restricted (e.g., to 150 MHz). For example, regulations imposed by a governing body may only allow radar operations to occur within a set range of frequencies or power levels. However, in some embodiments, the bandwidth of each chirp may be larger than 150 MHz. Multiple types of chirps of varying bandwidths, durations, and shapes (e.g., exponential, quadratic, step, hyperbolic, or sawtooth) may be stored in memory units, such as registers, coupled to the chirp generator 1208. In some embodiments, at least one type of chirp includes one or more second digital values that would provide a gap between each chirp of the FMCW signal. The chirp generator 1208 may receive an indication from upstream circuitry (e.g., a host processor) indicating which type of chirp is to be employed.

The chirp generator 1208 may be coupled to a DAC 1302. The DAC 1302 may generate a first baseband signal (e.g., the FMCW signal, or the set of chirps) using the first digital values provided by the chirp generator 1208. The first baseband signal may include at least the features described above with respect to FIG. 12. In some embodiments, the DAC 1302 may support a sampling rate higher than what is required for wireless transmission. The chirp generator 1208 may take advantage of the supported higher sampling rate to increase bandwidth or reduce transmission time of each chirp of the FMCW signal. The DAC 1302 may provide the first baseband signal to the first mixer 1214, which creates an RF signal to be transmitted by the first antenna 1218 by mixing the FMCW signal with an LO signal generated by the LO 1212, as described above with respect to FIG. 12. The RF signal may be amplified by the power amplifier 1306 before being transmitted by the first antenna 1218.

While the first antenna 1218 transmits the RF signal, the second antenna 1224 may be listening (e.g., observing, receiving) for reflected signals that correspond to the RF signal. The reflected signals may be the RF signal after reflecting off an object or objects (e.g., a person, a car, or another target). The reflected signals may pass through the LNA 1308. In some embodiments, the LNA 1308 may be designed to have a wide bandwidth to amplify all frequencies corresponding to the RF signal while also maintaining low noise performance across the range of the LNA 1308. The LNA 1308 may provide the reflected signals to the second mixer 1220 that extracts a second baseband signal (e.g., reflected FMCW signals) from the reflected signals by mixing the reflected signals with the LO signal, as described above with respect to FIG. 12. The second baseband signal may include a set of reflected chirps that corresponds to the set of chirps generated by the chirp generator 1208.

In some embodiments, the wireless device 1200 may include more than one second antenna 1224 that allows the processing device 1230 to estimate an angle of arrival (AOA). The wireless device 1200 may switch between the multiple second antennas 1224 automatically or based on an input of a user, such as by an external switch. In some embodiments, enabling the external switch causes multiple second antennas 1224 to both observe the reflected signals concurrently.

In some embodiments, the second antenna 1224 and the first antenna 1218 may be a same antenna. In these embodiments, the Wi-Fi TX chain 1216 and RX chain 1222 may be coupled by a transmit/receive (T/R) switch that allows the wireless device 1200 to send one or more chirps via the Wi-Fi TX chain 1216, enable the T/R switch, and receive reflected signals corresponding to those chirps on the RX chain 1222.

In some embodiments, a second RX chain may be added that is coupled to the first antenna 1218 by a T/R switch. By adding this second RX chain (and thus receiving a second set of reflect signals via the first antenna 1218), the wireless device 1200 may be able to determine angular details of the The second baseband signal may be provided to the ADC 1304, which generates second digital values from the second baseband signal. In some embodiments, as described above, the first antenna 1218 and the second antenna 1224 are not completely isolated, which may allow a certain amount of leakage (e.g., direct transmission) to occur from the first antenna 1218 to the second antenna 1224. To avoid saturating the ADC 1304, the overall gain of the RX chain may need to be limited. The ADC 1304 may provide the second digital values the digital dechirping logic 1310.

Employing the digital dechirping logic 1310 instead of analog dechirping logic to dechirp the second baseband signal (e.g., second baseband signal) can provide certain advantages, such as lower hardware complexity and lower cost implementation. However, employing the dechirping logic 1210 digitally may also pose certain challenges. For example, a signal-to-noise ratio (SNR) of a digitally-dechirped signal may be worse than an SNR of a dechirped signal produced by analog dechirping logic. When an analog signal is converted to a digital signal by an analog-to-digital converter (ADC), the continuous signal is quantized to a set of discrete values. This quantization process may introduce quantization noise, which can degrade the SNR. Additionally, digital processing can introduce digital processing noise to the set of discrete values. For example, numerical errors can accumulate in digital filters or transforms like fast Fourier transforms (FFTs). These challenges and other deficiencies may be overcome by increasing a number of chirps transmitted and reflected and utilizing coherent integration, as described above.

The digital dechirping logic 1310 may include at least the features of the dechirping logic 1210. In some embodiments, the digital dechirping logic 1310 may filter the leakage as described above from the second digital values. The digital dechirping logic 1310 may filter the leakage by utilizing a second LUT that includes known leakage strengths at different frequencies. The leakage strengths may be known based on (i) a distance between the first antenna 1218 and the second antenna 1224 and (ii) a signal strength of the RF signal transmitted via the first antenna 1218. After digitally filtering leakage caused by the lack of complete isolation between the first antenna 1218 and second antenna 1224, the digital dechirping logic 1310 may digitally mix the second digital values and the third digital values to generate first digital values. The first digital values may represent a beat signal as described above with respect to FIG. 12. After digital dechirping, the first digital values may be decimated to adhere to memory and compute restrictions of the wireless device 1300. After decimating, samples over the set of chirps may be averaged before being provided to upstream circuitry for further radar signal processing, such that the upstream circuitry receives a single chirp that represents the set of reflected chirps that were processed by the digital dechirping logic 1310. In some embodiments, the upstream circuitry may be a processing device, such as the processing device 1230 of FIG. 12. In some embodiments, the upstream circuitry may include processing logic that performs the operations of the presence detection logic 126 as described above with respect to FIGS. 1-8.

FIG. 14 is a flowchart illustrating a method 1400 of detecting a presence of a target, according to one embodiment. The method 1400 may be performed by processing logic that may comprise hardware (e.g., circuitry, dedicated logic, programmable logic, microcode, etc.), software, firmware, or a combination thereof. In one embodiment, the processing logic may be the processing device 1230 of FIG. 12. In some embodiments, the method 1400 may be performed by the wireless device 100 of FIG. 1, the wireless device 1200 of FIG. 12, the wireless device 1300 of FIG. 13, or the wireless device 1400 of FIG. 14. In at least one embodiment, the processing logic may include one or more processors and one or more computer readable media storing processor executable instructions which, when executed using the one or more processor, cause a device having the processing logic to performs the operations of the method 1400. The method 1400 can be performed by other devices described herein.

At block 1402, the processing logic may receive a first radar frame comprising leakage between a transmit (TX) antenna and a receive (RX) antenna of the wireless device.

At block 1404, the processing logic may receive a second radar frame comprising leakage between the TX antenna and the RX antenna. The processing logic may receive the second radar frame after receiving the first radar frame.

At block 1406, the processing logic may align the second radar frame to the first radar frame based on their respective leakages.

At block 1408, the processing logic may detect, using the aligned second radar frame, a presence of a target.

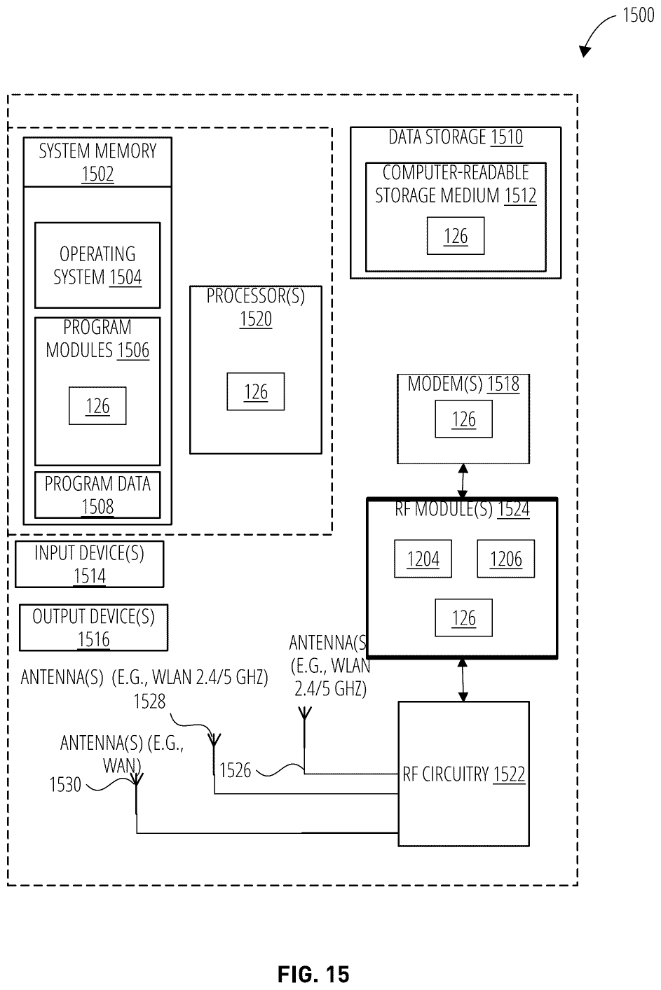

FIG. 15 is a block diagram of a wireless device 1500 with integrated radio and radar functionality according to one embodiment. The wireless device 1500 may correspond to the any devices described above with respect to FIG. 1 to FIG. 13. In the depicted embodiment, the wireless device 1500 includes the presence detection logic 126, the radar logic 1206, and the radio logic 1204. Alternatively, the wireless device 1500 may be other electronic devices, as described herein.

The wireless device 1500 includes one or more processor(s) 1520, such as one or more CPUs, microcontrollers, field-programmable gate arrays, or other types of processors. In at least one embodiment, the processor(s) 1520 may perform one or more operations related to the presence detection logic 126, as described herein. The wireless device 1500 also includes system memory 1502, which may correspond to any combination of volatile and/or non-volatile storage mechanisms. The system memory 1502 stores information that provides operating system 1504, various program modules 1506, program data 1508, and/or other components. In one embodiment, the system memory 1502 stores instructions of methods to control the operation of the wireless device 1500. In at least one embodiment, the program modules 1506 may store instructions related to one or more operations of the presence detection logic 126. The wireless device 1500 performs functions by using the processor(s) 1520 to execute instructions provided by the system memory 1502.

The wireless device 1500 also includes a data storage device 1510 that may be composed of one or more types of removable storage and/or one or more types of non-removable storage. The data storage device 1510 includes a computer-readable storage medium 1512 on which is stored one or more sets of instructions embodying any of the methodologies or functions described herein. In at least one embodiment, the computer-readable storage medium 1512 may store instructions related to some or all of the operations of the presence detection logic 126, as described herein. Instructions for the program modules 1506 may reside, completely or at least partially, within the computer-readable storage medium 1512, system memory 1502, and/or within the processor(s) 1520 during execution thereof by the wireless device 1500, the system memory 1502 and the processor(s) 1520 also constituting computer-readable media. The wireless device 1500 may also include one or more input device(s) 1514 (keyboard, mouse device, specialized selection keys, etc.) and one or more output device(s) 1516 (displays, printers, audio output mechanisms, etc.).

The wireless device 1500 further includes one or more modem(s) 1518 to allow the wireless device 1500 to communicate via wireless connections (e.g., such as provided by the wireless communication system) with other computing devices, such as remote computers, an item providing system, and so forth. The modem(s) 1518 can be connected to one or more radio frequency (RF) modules 1524. The RF module(s) 1524 may be a WLAN module, a WAN module, a wireless personal area network (WPAN) module, a Global Positioning system (GPS) module, or the like. In some embodiments, the RF module(s) 1524 may perform one or more operations related to the presence detection logic 126, as described herein. The antenna structures (antenna(s) 1526, 1528, 1530) are coupled to the RF circuitry 1522, which is coupled to the modem(s) 1518. The RF circuitry 1522 may include radio front-end circuitry, antenna switching circuitry, impedance matching circuitry, or the like. The antenna(s) 1526, 1528, 1530 may be GPS antennas, a near field communication (NFC) antennas, other WAN antennas, WLAN or PAN antennas, or the like. The modem(s) 1518 allows the wireless device 1500 to handle both voice and non-voice communications (such as communications for text messages, multimedia messages, media downloads, web browsing, etc.) with a wireless communication system. The modem(s) 1518 may provide network connectivity using any type of mobile network technology including, for example, cellular digital packet data (CDPD), general packet radio service (GPRS), EDGE, universal mobile telecommunications system (UMTS), 1 times radio transmission technology (1×RTT), evaluation data optimized (EVDO), high-speed downlink packet access (HSDPA), Wi-Fi®, Long Term Evolution (LTE) and LTE Advanced (sometimes generally referred to as 4G), etc. In at least one embodiment, the modem(s) 1518 may also perform one or more operations related to the presence detection logic 126, as described herein.

The modem(s) 1518 may generate signals and send these signals to the antenna(s) 1526 of a first type (e.g., WLAN 5 GHZ), antenna(s) 1528 of a second type (e.g., WLAN 2.4 GHz), and/or antenna(s) 1528 of a third type (e.g., WAN), via RF circuitry 1522, and RF module(s) 1524 as described herein. Antenna(s) 1526, 1528, 1530 may be configured to transmit in different frequency bands and/or using different wireless communication protocols. The antenna(s) 1526, 1528, 1530 may be directional, omnidirectional, or non-directional antennas. In addition to sending data, antenna(s) 1526, 1528, 1530 may also receive data, which is sent to appropriate RF modules connected to the antennas. One of the antenna(s) 1526, 1528, 1530 may be any combination of the antenna structures described herein.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A first wireless device comprising:
a first antenna coupled to a transmission (TX) chain;
a second antenna coupled to a receive (RX) chain;
one or more processors; and
one or more computer readable media storing processor executable instructions which, when executed using the one or more processors, cause the first wireless device to:
send, during a first operational cycle of a radar mode, a first radar signal via the TX chain and the first antenna;
generate first radar data based on first radar returns corresponding to the first radar signal, wherein the first radar returns comprise leakage between the first and second antennas;
send, during a first operational cycle of a radio mode, data to a second wireless device via the TX chain and the first antenna;
send, during a second operational cycle of the radar mode, a second radar signal via the TX chain and the first antenna; and
generate second radar data based on second radar returns corresponding to the second radar signal, wherein the second radar returns comprise leakage between the first and second antennas;
align the second radar data to the first radar data based on the leakage of the first and second radar returns; and
detect, using the aligned second radar data, a presence of a person within a field of view (FOV) of radar operations of the first wireless device.

2. The first wireless device of claim 1, wherein to detect the presence of the person, the processor executable instructions which, when executed using the one or more processors, cause the first wireless device to generate third radar data by cross-frame cancellation the aligned second radar data with the first radar data, wherein the third radar data is used to detect the presence of the person.

3. The first wireless device of claim 1, wherein the first operational cycle of the radar mode occurs before the first operational cycle of the radio mode, and the second operational cycle of the radar mode occurs after the first operational cycle of the radio mode.

4. A method of operating a first wireless device, the method comprising:
receiving a first radar frame comprising leakage between a transmit (TX) antenna and a receive (RX) antenna of the first wireless device;
receiving, after receiving the first radar frame, a second radar frame comprising leakage between the TX antenna and the RX antenna;
aligning the second radar frame to the first radar frame based on their respective leakages; and
based on the aligning of the second radar frame to the first radar frame, detecting a presence.

5. The method of operating the first wireless device of claim 4, further comprising sending, after receiving the first radar frame and before receiving the second radar frame, data to a second wireless device via the TX antenna.

6. The method of operating the first wireless device of claim 4, further comprising:
generating a first radar data set representing a first range fast Fourier transform (FFT) using the first radar frame; and
generating a second radar data set representing a second range FFT using the second radar frame, wherein aligning the second radar frame to the first radar frame comprises aligning the second radar data set to the first radar data set, and wherein aligning the second radar data set to the first radar data set generates a third radar data set representing a cross-frame cancellation between the first and second radar frames.

7. The method of operating the first wireless device of claim 6, wherein the leakage of the first radar frame corresponds to a first magnitude value of the first radar data set and the leakage of the second radar frame corresponds to a second magnitude value of the second radar data set, and wherein the second radar data set is aligned to the first radar data set using the first and second magnitude values.

8. The method of operating the first wireless device of claim 6, wherein the leakage of the first radar frame corresponds to a first phase value of the first data set and the leakage of the second radar frame corresponds to a second phase value of the second data set, and wherein the second radar data set is aligned to the first radar data set using the first and second phase values.

9. The method of operating the first wireless device of claim 6, wherein the third radar data set comprises a first peak value that satisfies a first threshold, and wherein detecting the presence of the target comprises determining that a threshold number of consecutive radar data sets each representing cross-frame cancellation between radar frames comprise respective peak values that each satisfy respective thresholds.

10. The method of operating the first wireless device of claim 6, further comprising generating a fourth radar data set by combining the third radar data set and a plurality of historical radar data sets each corresponding to a historical radar frame, wherein detecting the presence of the target comprises determining that a threshold number of radar frames within a sliding window comprising the fourth radar data set indicate the presence of the target.

11. The method of operating the first wireless device of claim 10, wherein detecting the presence of the target comprises determining that a threshold number of radar frames within a sliding window comprising the fourth radar data set indicate the presence of the target.

12. A first wireless device comprising:
a transmit (TX) antenna and a receive (RX) antenna;
one or more processors; and
one or more computer readable media storing processor executable instructions which, when executed using the one or more processors, cause the first wireless device to:
receive a first radar frame comprising leakage between a transmit (TX) antenna and a receive (RX) antenna of the first wireless device;
receive, after receiving the first radar frame, a second radar frame comprising leakage between the TX antenna and the RX antenna;
align the second radar frame to the first radar frame based on their respective leakages; and
detect, using the aligned second radar frame, a presence of a target.

13. The first wireless device of claim 12, wherein the processor executable instructions which, when executed using the one or more processors, cause the first wireless device to send, after receiving the first radar frame and before receiving the second radar frame, data to a second wireless device via the TX antenna.

14. The first wireless device of claim 13, wherein the first wireless device comprises an application processor (AP), a microcontroller unit (MCU), and a connectivity chipset, wherein the first and second radar frames are received by the MCU from the connectivity chipset, and wherein the data sent to the second wireless device is received by the connectivity chipset from the AP.

15. The first wireless device of claim 12, wherein the processor executable instructions which, when executed using the one or more processors, cause the first wireless device to:
generate a first radar data set representing a first range fast Fourier transform (FFT) using the first radar frame; and
generate a second radar data set representing a second range FFT using the second radar frame, wherein aligning the second radar frame to the first radar frame comprises aligning the second radar data set to the first radar data set, and wherein aligning the second radar data set to the first radar data set generates a third radar data set representing a cross-frame cancellation between the first and second radar frames.

16. The first wireless device of claim 15, wherein the leakage of the first radar frame corresponds to a first magnitude value of the first radar data set and the leakage of the second radar frame corresponds to a second magnitude value of the second radar data set, and wherein the second radar data set is aligned to the first radar data set using the first and second magnitude values.

17. The first wireless device of claim 16, wherein the leakage of the first radar frame corresponds to a first phase value and the leakage of the second radar frame corresponds to a second phase value, and wherein the second radar data set is aligned to the first radar data set using the first and second phase values.

18. The first wireless device of claim 15, wherein the third radar data set comprises a first peak value that satisfies a first threshold, and wherein to detect the presence of the target, the processor executable instructions which, when executed using the one or more processors, cause the first wireless device to determine that a threshold number of consecutive radar data sets each representing cross-frame cancellation between radar frames comprise respective peak values that each satisfy respective thresholds.

19. The first wireless device of claim 15, wherein the processor executable instructions which, when executed using the one or more processors, cause the first wireless device to:
generate a fourth radar data set by combining the third radar data set and a plurality of historical radar data sets each corresponding to a historical radar frame.

20. The first wireless device of claim 19, wherein to detect the presence of the target, the processor executable instructions which, when executed using the one or more processors, cause the first wireless device to determine that a threshold number of radar frames within a sliding window comprising the fourth radar data set indicate the presence of the target.
